(19) United States
(12) Patent Application Publication
(10) Pub. No.: US 2025/0317552 A1
(43) Pub. Date: Oct. 9, 2025

(54) METHOD, APPARATUS, AND MEDIUM FOR VIDEO PROCESSING

(71) Applicant: Bytedance Inc., Los Angeles, CA (US)

(72) Inventors: Kai ZHANG, Los Angeles, CA (US); Li ZHANG, Los Angeles, CA (US)

(21) Appl. No.: 19/246,500

(22) Filed: Jun. 23, 2025

Related U.S. Application Data
(63) Continuation of application No. PCT/US2023/085771, filed on Dec. 22, 2023.
(60) Provisional application No. 63/435,105, filed on Dec. 23, 2022.

(51) Int. Cl. H04N 19/103; H04N 19/176

(52) U.S. Cl. CPC H04N 19/103; H04N 19/176

(57) ABSTRACT

Embodiments of the present disclosure provide a solution for video processing. A method for video processing is proposed. The method comprises: adjusting, for a conversion between a current video block of a video and a bitstream of the video, a prediction for the current video block, the prediction being determined based on a cross-component prediction scheme; and performing the conversion based on the adjusted prediction.

### CROSS REFERENCE

This application is a continuation of International Application No. PCT/US2023/085771, filed on Dec. 22, 2023, which claims the benefit of U.S. Provisional Application No. 63/435,105, filed on Dec. 23, 2022. The entire contents of these applications are hereby incorporated by reference in their entireties.

### FIELDS

Embodiments of the present disclosure relates generally to video processing techniques, and more particularly, to cross-component prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: adjusting, for a conversion between a current video block of a video and a bitstream of the video, a prediction for the current video block, the prediction being determined based on a cross-component prediction scheme; and performing the conversion based on the adjusted prediction.

According to the method in accordance with the first aspect of the present disclosure, a prediction for a video block determined based on a cross-component prediction scheme is adjusted before being further processed. Compared with the conventional solution, the proposed method can advantageously improve the coding quality.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: adjusting a prediction for a current video block of the video, the prediction being determined based on a cross-component prediction scheme; and generating the bitstream based on the adjusted prediction.

In a fifth aspect, a method for storing a bitstream of a video is proposed. The method comprises: adjusting a prediction for a current video block of the video, the prediction being determined based on a cross-component prediction scheme; generating the bitstream based on the adjusted prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates nominal vertical and horizontal locations of 4:2:2 luma and chroma samples in a picture;

FIG. 5 illustrates example of encoder block diagram;

FIG. 6 illustrates 67 intra prediction modes;

FIG. 7 illustrates reference samples for wide-angular intra prediction;

FIG. 8 illustrates problem of discontinuity in case of directions beyond 45°;

FIG. 9 illustrates locations of the samples used for the derivation of α and β;

FIG. 10 illustrates an example of classifying the neighboring samples into two groups;

FIG. 11A is a schematic diagram illustrating definition of samples used by PDPC applied to a diagonal top-right mode;

FIG. 11B is a schematic diagram illustrating definition of samples used by PDPC applied to a diagonal bottom-left mode;

FIG. 11C is a schematic diagram illustrating definition of samples used by PDPC applied to an adjacent diagonal top-right mode;

FIG. 11D is a schematic diagram illustrating definition of samples used by PDPC applied to an adjacent diagonal bottom-left mode;

FIG. 12 illustrates gradient approach for non-vertical/non-horizontal mode;

FIG. 13 illustrates nScale values with respect to nTbH and mode number; for all nScale<0 cases gradient approach is used;

FIG. 14 illustrates flowchart: current PDPC (left), and proposed PDPC (right);

FIG. 15 illustrates neighboring blocks (L, A, BL, AR, AL) used in the derivation of a general MPM list;

FIG. 16 illustrates example on proposed intra reference mapping;

FIG. 17 illustrates example of four reference lines neighboring to a prediction block;

FIG. 18A is a schematic diagram illustrating examples of sub-partitions for 4×8 and 8×4 CUs;

FIG. 18B is a schematic diagram illustrating examples of sub-partitions for CUs other than 4×8, 8×4 and 4×4;

FIG. 19 illustrates matrix weighted intra prediction process;

FIG. 20 illustrates target samples, template samples and the reference samples of template used in the DIMD;

FIG. 21 illustrates proposed intra block decoding process;

FIG. 22 illustrates HoG computation from a template of width 3 pixels;

FIG. 23 illustrates Prediction fusion by weighted averaging of two HoG modes and planar;

FIG. 24 illustrates spatial part of the convolutional filter;

FIG. 25 illustrates reference area (with its paddings) used to derive the filter coefficients;

FIG. 26 illustrates four Sobel based gradient patterns for GLM;

FIG. 27 illustrates spatial samples used for GL-CCCM;

FIG. 28 illustrates non-downsampled luma samples;

FIG. 29 illustrates spatial GPM candidates;

FIG. 30 illustrates GPM template;

FIG. 31 illustrates GPM boundary;

FIG. 32 illustrates binarization of cross-component prediction modes in ECM;

FIG. 33 illustrates examples of filtering taps;

FIG. 34 illustrates examples of padding;

FIG. 35A illustrates an example of filtering with neighboring reconstructed samples;

FIG. 35B illustrates a further example of filtering with neighboring reconstructed samples;

FIG. 36 illustrates an example of filtering with neighboring reconstructed samples and padding samples;

FIG. 37A illustrates an example of the coding tree to code cross-component prediction modes;

FIG. 37B illustrates a further example of the coding tree to code cross-component prediction modes;

FIG. 38 illustrates a flowchart of a method for video processing in accordance with embodiments of the present disclosure; and

FIG. 39 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

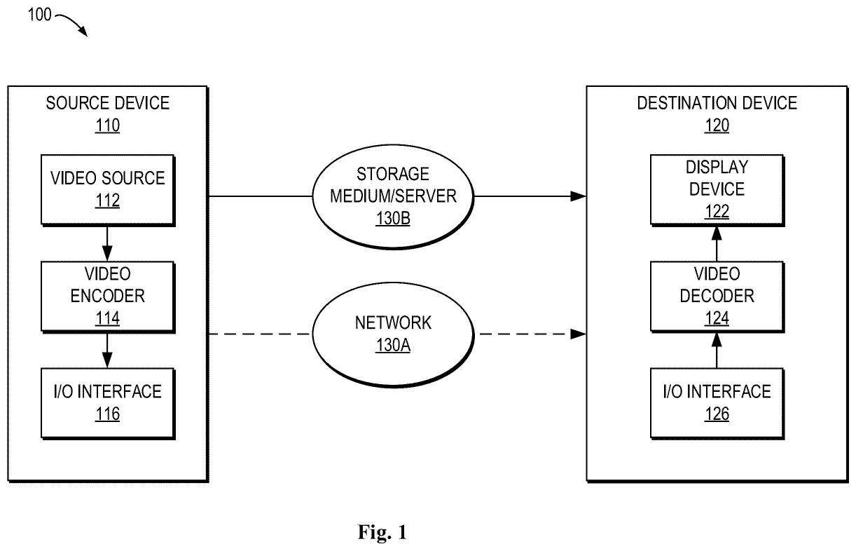

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

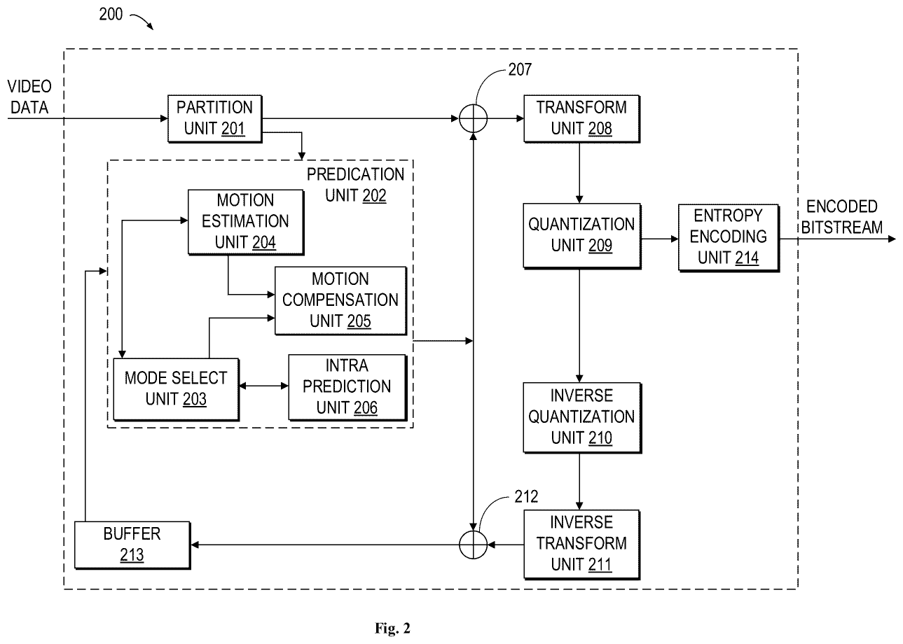

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

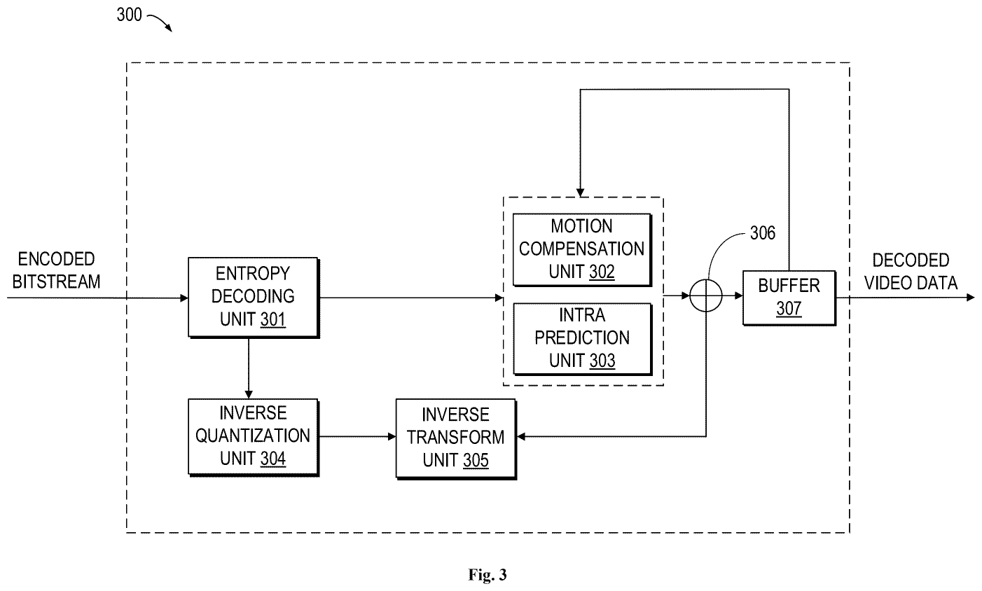

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

Embodiments are related to video coding technologies. Specifically, it is related to chroma coding. It may be applied to the existing video coding standard like HEVC, or Versatile Video Coding (VVC). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Color Space and Chroma Subsampling

Color space, also known as the color model (or color system), is an abstract mathematical model which simply describes the range of colors as tuples of numbers, typically as 3 or 4 values or color components (e.g., RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1.4:4:4

Each of the three Y′CbCr components have the same sample rate, thus there is no chroma subsampling. This scheme is sometimes used in high-end film scanners and cinematic post production.

2.1.2.4:2:2

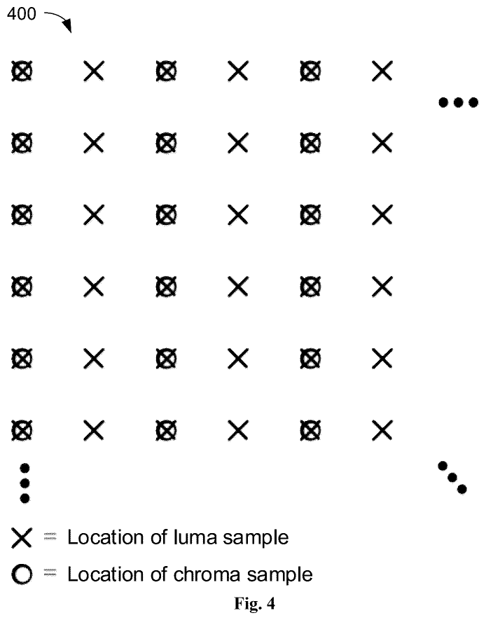

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft.

2.1.3.4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

TABLE 2-1
SubWidthC and SubHeightC values derived from chroma_format_idc
and separate_colour_plane_flag

| | separate_{—} | | | |
|---|---|---|---|---|
| chroma_{—} | colour_plane_{—} | Chroma | | |
| format_idc | flag | format | SubWidthC | SubHeightC |
| 0 | 0 | Monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2. Coding Flow of a Typical Video Codec

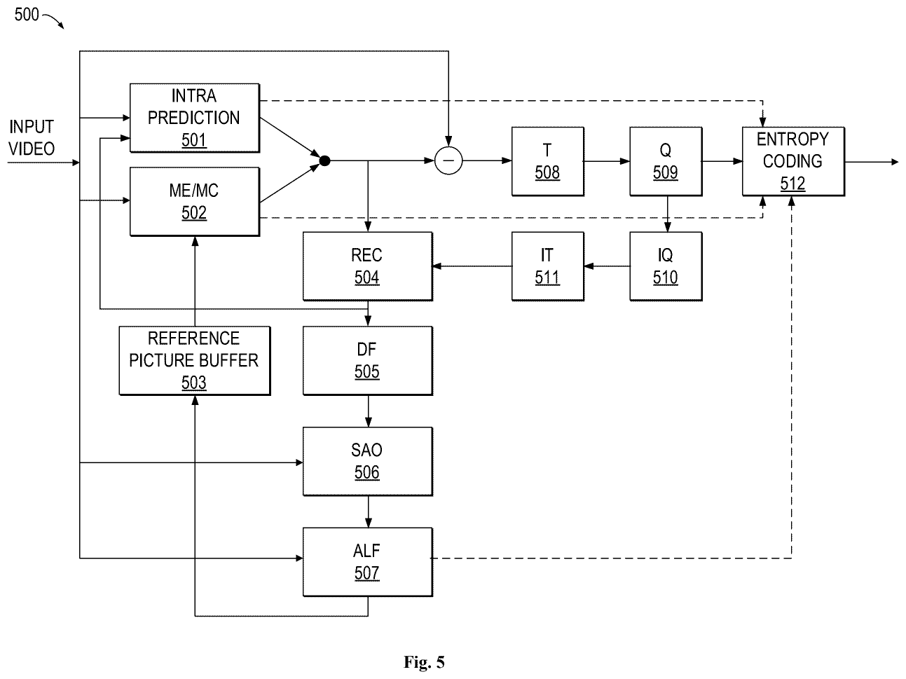

FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.3. Intra Mode Coding with 67 Intra Prediction Modes

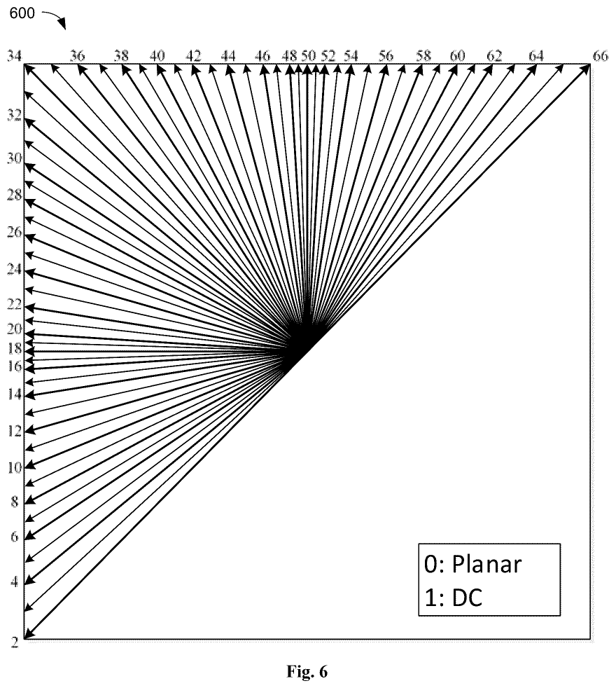

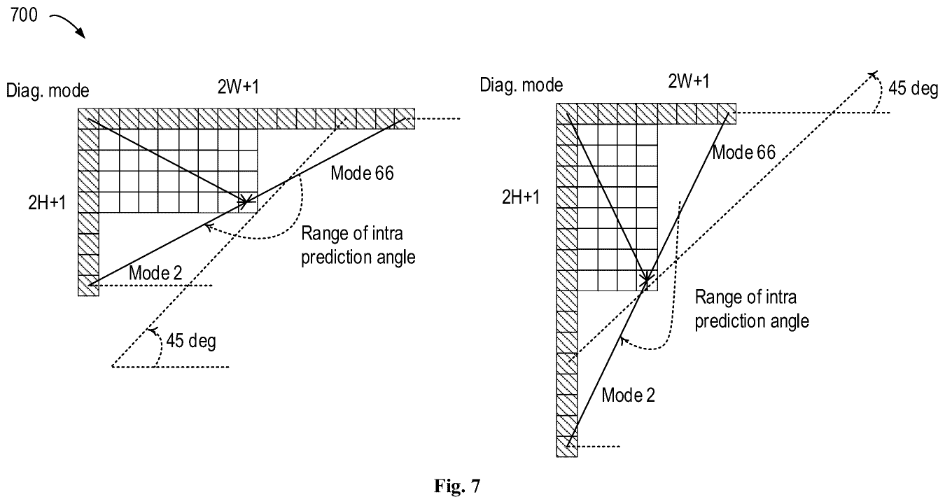

To capture the arbitrary edge directions presented in natural video, the number of directional intra modes is extended from 33, as used in HEVC, to 65, as shown in FIG. 6, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1. Wide Angle Intra Prediction

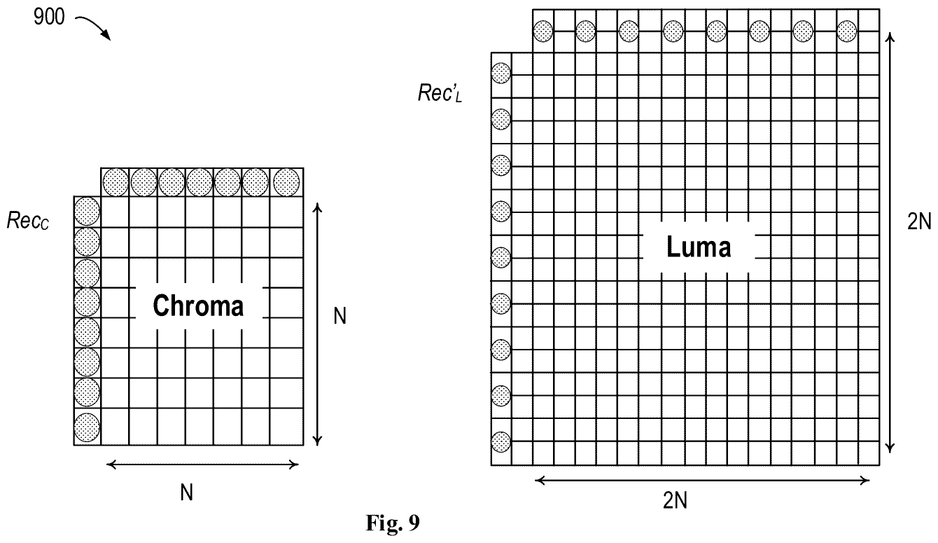

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged. To support these prediction directions, the top reference with length 2W+1, and the left reference with length 2H+1, are defined as shown in FIG. 9.

The number of replaced modes in wide-angular direction mode depends on the aspect ratio of a block. The replaced intra prediction modes are illustrated in Table 2-2.

TABLE 2-2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, 66 |

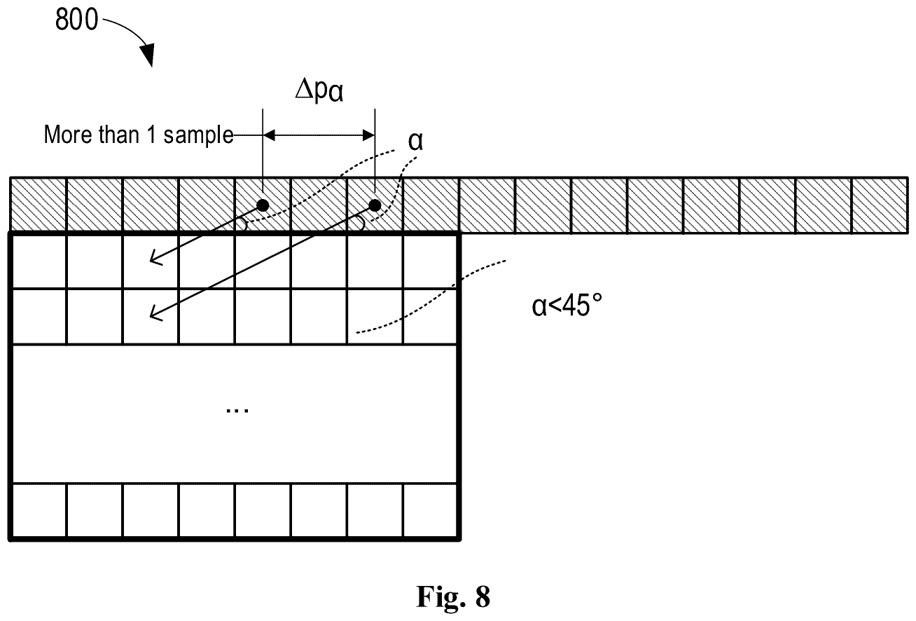

As shown in FIG. 8, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.4. Intra Prediction Mode Coding for Chroma Component

For the chroma component of an intra PU, the encoder selects the best chroma prediction modes among five modes including Planar, DC, Horizontal, Vertical and a direct copy of the intra prediction mode for the luma component. The mapping between intra prediction direction and intra prediction mode number for chroma is shown in Table 2-3.

When the intra prediction mode number for the chroma component is 4, the intra prediction direction for the luma component is used for the intra prediction sample generation for the chroma component. When the intra prediction mode number for the chroma component is not 4 and it is identical to the intra prediction mode number for the luma component, the intra prediction direction of 66 is used for the intra prediction sample generation for the chroma component.

### 2.5. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.6. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.7. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 2 - 1 )$$

where pred_{C}(i, j) represents the predicted chroma samples in a CU and rec_{L}(i, j) represents the down-sampled reconstructed luma samples of the same CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when LM mode is applied;
W′=W+H when LM_T mode is applied;
H′=H+W when LM_L mode is applied.

The above neighbouring positions are denoted as S[0, −1] . . . S[W′−1, −1] and the left neighbouring positions are denoted as S[−1, 0] . . . S[−1, H′−1]. Then the four samples are selected as:
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM_T mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available.

The four neighbouring luma samples at the selected positions are down-sampled and compared four times to find two larger values: y⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) ≫ 1 ; {X}_{b} = ( {x}_{B}^{0} + {x}_{B}^{1} + 1 ) ≫ 1 ; {Y}_{a} = ( {y}_{A}^{0} + {y}_{A}^{1} + 1 ) ≫ 1 ; {Y}_{b} = ( {y}_{B}^{0} + {y}_{B}^{1} + 1 ) ≫ 1 \qquad ( 2 - 2 )$$

Finally, the linear model parameters α and β are obtained according to the following equations.

$$α = \frac{{Y}_{a} - {Y}_{b}}{{X}_{a} - {X}_{b}} \qquad ( 2 - 3 )$$

$$β = {Y}_{b} - α \cdot {X}_{b} \qquad ( 2 - 4 )$$

FIG. 9 shows an example of the location of the left and above samples and the sample of the current block involved in the CCLM mode.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 2 - 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_T, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ \text{} {rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] ≫ 3 \qquad ( 2 - 6 )$$

$${rec}_{L}^{′} ( i , j ) = [ {rec}_{L} ( 2 i , 2 j - 1 ) + {rec}_{L} ( 2 i - 1 , 2 j ) + 4 \cdot {rec}_{L} ( 2 i , 2 j ) + {rec}_{L} ( 2 i + 1 , 2 j ) + {rec}_{L} ( 2 i , 2 j + 1 ) + 4 ] ≫ 3 \qquad ( 2 - 7 )$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five conventional intra modes and three cross-component linear model modes (LM, LM_T, and LM_L). Chroma mode signalling and derivation process are shown in Table 2-3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 2-3
Derivation of chroma prediction mode
from luma mode when CCLM is enabled

| | Corresponding luma intra prediction mode | | | | |
|---|---|---|---|---|---|
| Chroma | | | | | X (0 <= |
| prediction mode | 0 | 50 | 18 | 1 | X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2-4.

TABLE 2-4
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2-4, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LMJT (1). For this case, when sps_cclm_enabled_flag is 0, the first bin of the binarization table for the corresponding intra_chroma-pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2-4 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM;
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.8. Multi-Model Linear Model (MMLM)

With MMLM, there can be more than one linear models between the luma samples and chroma samples in a CU. In this method, neighboring luma samples and neighboring chroma samples of the current block are classified into several groups, each group is used as a training set to derive a linear model (i.e., particular α and β are derived for a particular group). Furthermore, the samples of the current luma block is also classified based on the same rule for the classification of neighboring luma samples.

The neighboring samples can be classified into M groups, where M is 2 or 3. The MMLM method with M=2 and M=3 are designed as two appended Chroma prediction modes named MMLM2 and MMLM3, besides the original LM mode. The encoder chooses the optimal mode in the RDO process and signal the mode.

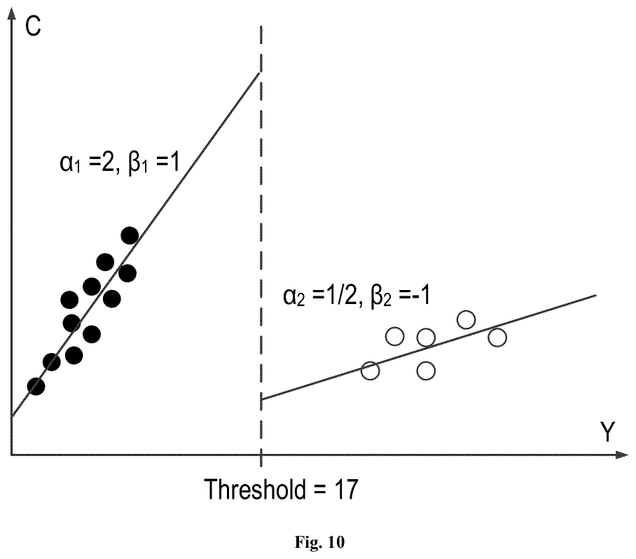

When M is equal to 2, FIG. 10 shows an example of classifying the neighboring samples into two groups. Threshold is calculated as the average value of the neighboring reconstructed Luma samples. A neighboring sample with Rec′L[x,y]<=Threshold Rec′_{Z}[x,y]≤Threshold is classified into group 1; while a neighboring sample with Rec′_{L}[x,y]>Threshold Rec′L[x,y]>Threshold is classified into group 2. Similar to CCLM, there are 3 modes in MMLM, namely MMLM, MMLM_T, and MMLM_L. Two models are derived as:

$$\{ \begin{matrix}{Pred}_{C} [ x , y ] = {α}_{1} \times {Rec}_{L}^{′} [ x , y ] + {β}_{1} if {Rec}_{L}^{′} [ x , y ] \leq Threshold \\ {Pred}_{C} [ x , y ] = {α}_{2} \times {Rec}_{L}^{′} [ x , y ] + {β}_{2} if {Rec}_{L}^{′} [ x , y ] > Threshold\end{matrix} \qquad ( 2 - 8 )$$

The threshold which is the average of the luma reconstructed neighboring samples. The linear model of each class is derived by using the Least-Mean-Square (LMS) method, if enabled, or min/max method of VVC.

### 2.9. Position Dependent Intra Prediction Combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.

The prediction sample pred(x′y′) is predicted using an intra prediction mode (DC, planar, angular) and a linear combination of reference samples according to the Equation 2-8 as follows:

$$pred ( {x}^{′} , {y}^{′} ) = Clip ( 0 , ( 1 ≪ BitDepth ) - 1 , ( wL \times {R}_{- 1 , {y}^{′}} + wT \times {R}_{{x}^{′} , - 1} + ( 64 - w L - w T ) \times p r ed ( {x}^{′} , {y}^{′} ) + 32 ) ≫ 6 ) \qquad ( 2 - 9 )$$

where R_{x,-1}, R_{-1,y} represent the reference samples located at the top and left boundaries of current sample (x, y), respectively.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

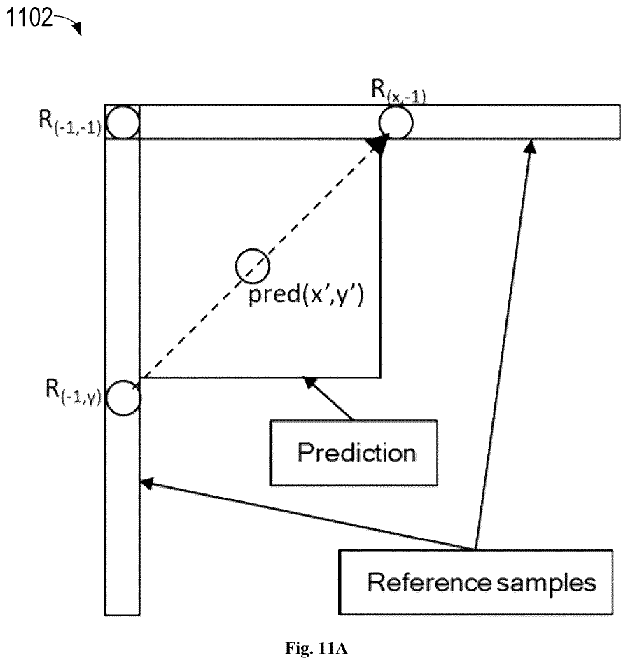

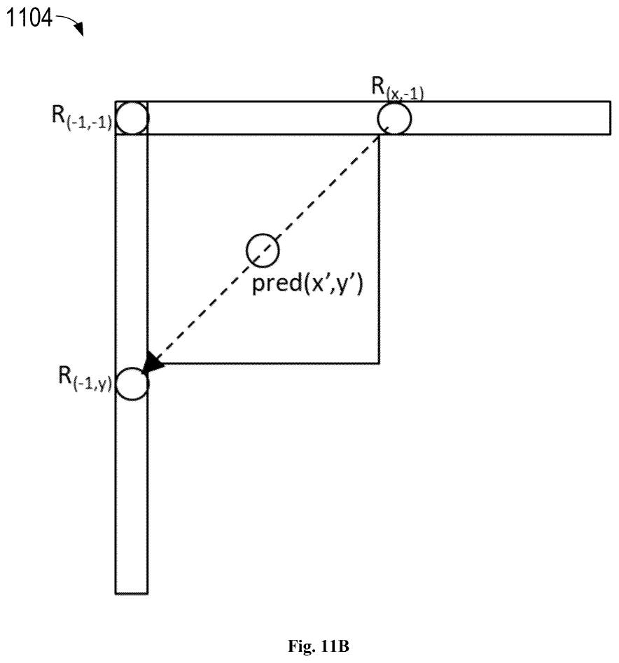

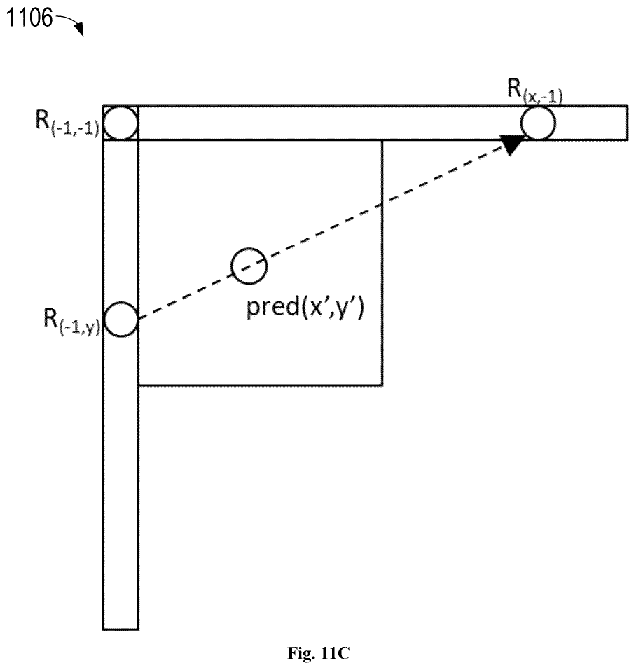

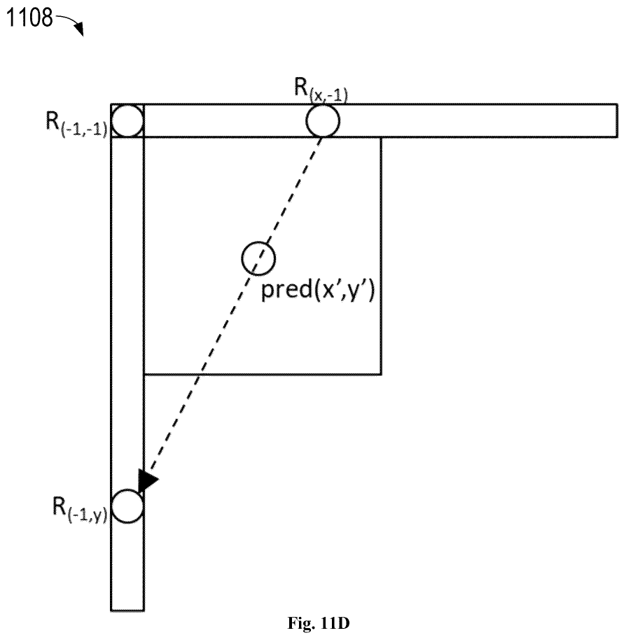

FIGS. 11A-11D illustrate the definition of reference samples (R_{x,-1} and R_{-1,y}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,y} could be located in fractional sample position. In this case, the sample value of the nearest integer sample location is used.

### 2.10. Gradient PDPC

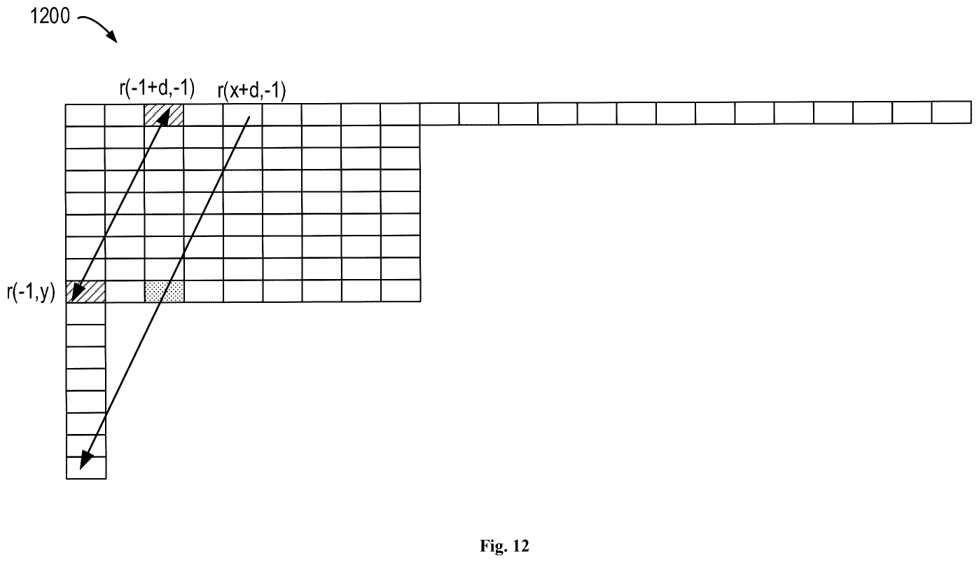

The gradient based approach is extended for non-vertical/non-horizontal mode, as shown in FIG. 12. Here, the gradient is computed as r(−1, y)−r(−1+d, −1), where d is the horizontal displacement depending on the angular direction. A few points to note here:

The gradient term r(−1, y)−r(−1+d, −1) is needed to be computed once for every row, as it does not depend on the x position.

The computation of d is already part of original intra prediction process which can be reused, so a separate computation of d is not needed. Accordingly, d is in 1/32 pixel accuracy.

We have used two tap (linear) filtering when d is at fractional position, i.e., if dPos is the displacement in 1/32 pixel accuracy, dInt is the (floored) integer part (dPos>>5), and dFract is the fractional part in 1/32 pixel accuracy (dPos & 31), then r(−1+d) is computed as:

$$r ( - 1 + d ) = ( 32 - dFrac ) * r ( - 1 + dInt ) + dFrac * r ( - 1 + dInt + 1 )$$

This 2 tap filtering is performed once per row (if needed), as explained in a.

Finally, the prediction signal is computed:

$$p ( x , y ) = \text{} Clip ( \text{} ( ( 64 - w L ( x ) ) * p ( x , y ) + wL ( x ) * ( r ( - 1 , y ) - r ( - 1 + d , - 1 ) ) + 32 ) ≫ 6 ) ,$$

where wL(x)=32>>((x<1)>>nScale2), and nScale2=(log 2(nTbH)+log 2(nTbW)−2)>>2, which are the same as vertical/horizontal mode. In a nutshell, the same process is applied compared to vertical/horizontal mode (in fact, d=0 indicates vertical/horizontal mode).

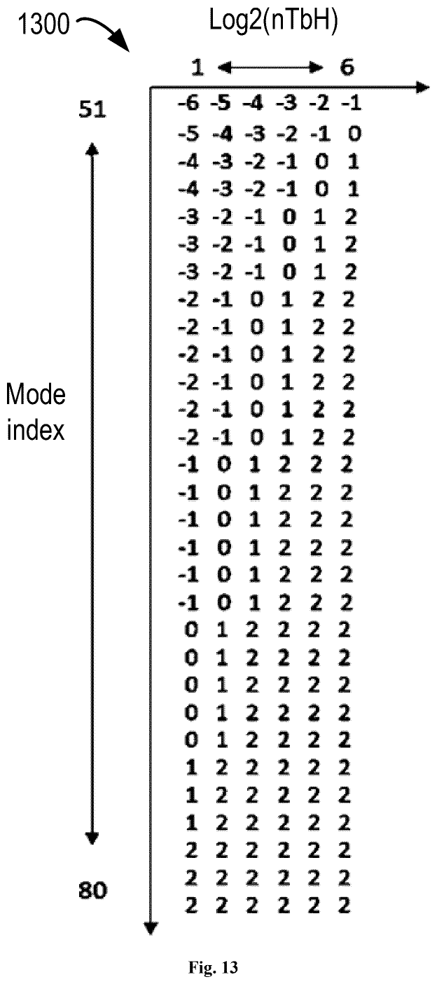

Second, we activate the gradient based approach for non-vertical/non-horizontal mode when (nScale<0) or when PDPC can't be applied due to unavailability of secondary reference sample. We have shown the values of nScale in FIG. 13, with respect to TB size and angular mode, to better visualize the cases where gradient approach is used. Additionally, in FIG. 14, we have shown the flowchart for current and proposed PDPC.

### 2.11. Secondary MPM

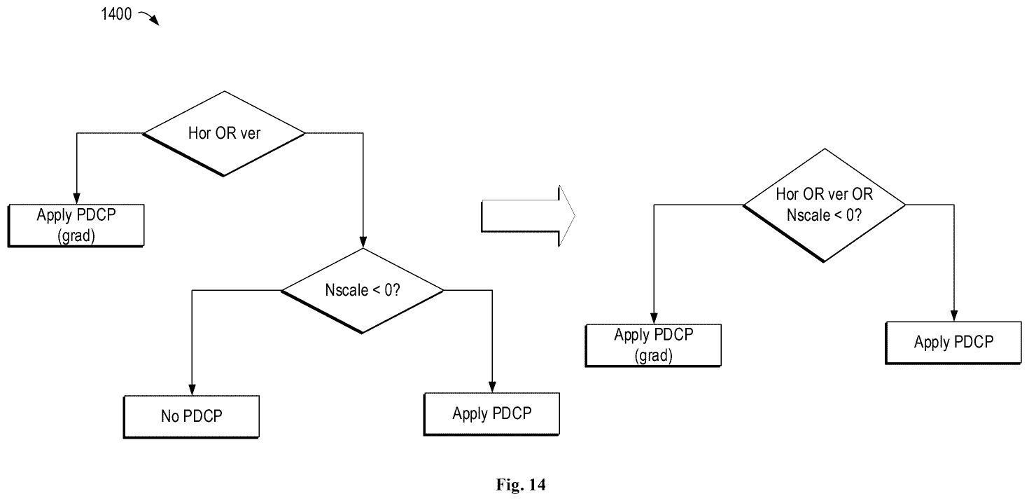

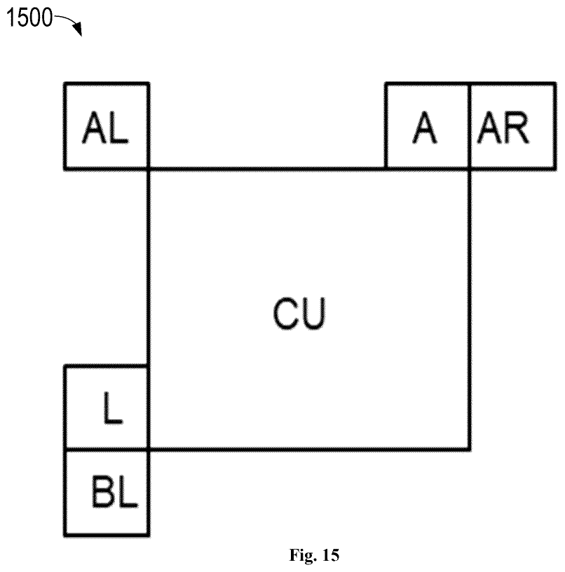

The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 15, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.12.6-Tap Intra Interpolation Filter

To improve prediction accuracy, it is proposed to replace 4-tap Cubic interpolation filter with 6-tap interpolation filter, the filter coefficients are derived based on the same polynomial regression model, but with polynomial order of 6.

Filter coefficients are listed below,
{0, 0, 256, 0, 0, 0}, //0/32 position
{0, −4, 253, 9, −2, 0}, //1/32 position
{1, −7, 249, 17, −4, 0}, //2/32 position
{1, −10, 245, 25, −6, 1}, //3/32 position
{1, −13, 241, 34, −8, 1}, //4/32 position
{2, −16, 235, 44, −10, 1}, //5/32 position
{2, −18, 229, 53, −12, 2}, //6/32 position
{2, −20, 223, 63, −14, 2}, //7/32 position
{2, −22, 217, 72, −15, 2}, //8/32 position
{3, −23, 209, 82, −17, 2}, //9/32 position
{3, −24, 202, 92, −19, 2}, //10/32 position
{3, −25, 194, 101, −20, 3}, //11/32 position
{3, −25, 185, 111, −21, 3}, //12/32 position
{3, −26, 178, 121, −23, 3}, //13/32 position
{3, −25, 168, 131, −24, 3}, //14/32 position
{3, −25, 159, 141, −25, 3}, //15/32 position
{3, −25, 150, 150, −25, 3}, //half-pel position

The reference samples used for interpolation come from reconstructed samples or padded as in HEVC, so that the conditional check on reference sample availability is not needed.

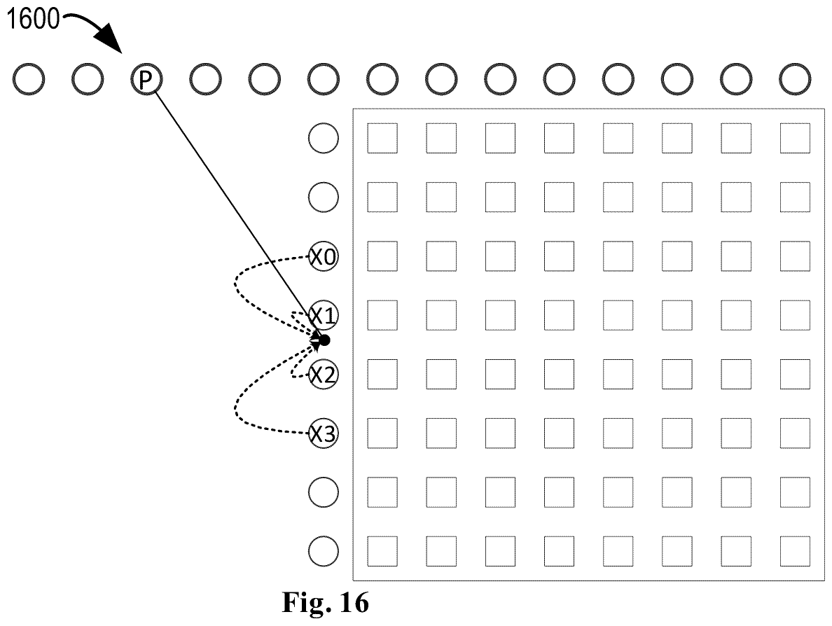

Instead of using nearest rounding operation to derive the extended Intra reference sample, it is proposed to use 4-tap Cubic interpolation filter. As shown in an example in FIG. 16, to derive the value of reference sample P, a four tap interpolation filter is used, while in JEM-3.0 or HM, P is directly set as X1.

### 2.13. Multiple Reference Line (MRL) Intra Prediction

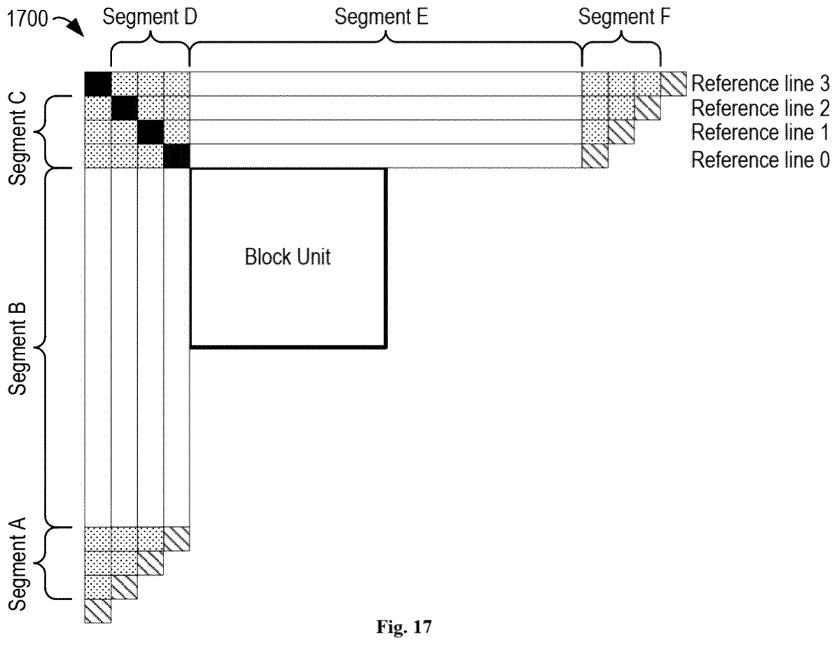

Multiple reference line (MRL) intra prediction uses more reference lines for intra prediction. In FIG. 17, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 2) are used.

The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.14. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\frac{M}{2} \times 64 chroma TBs .$$

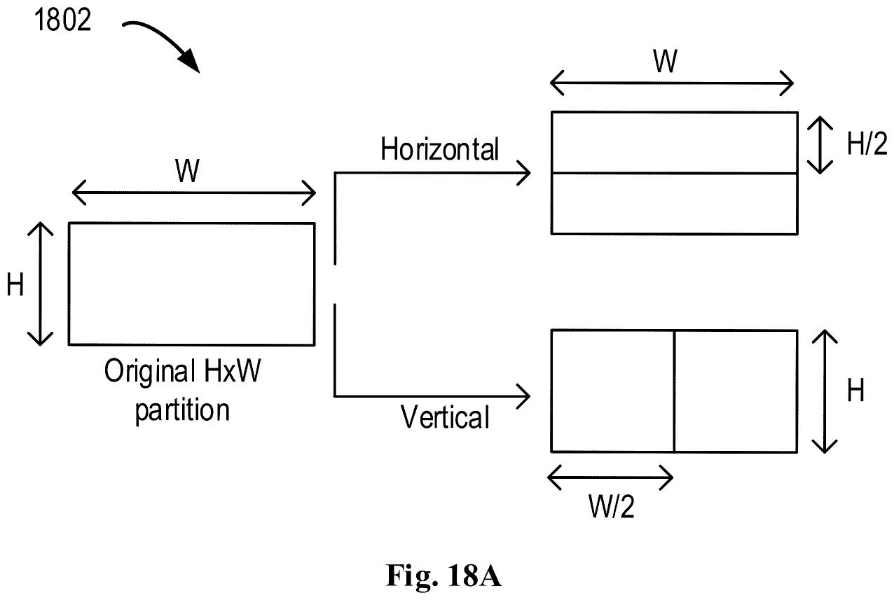

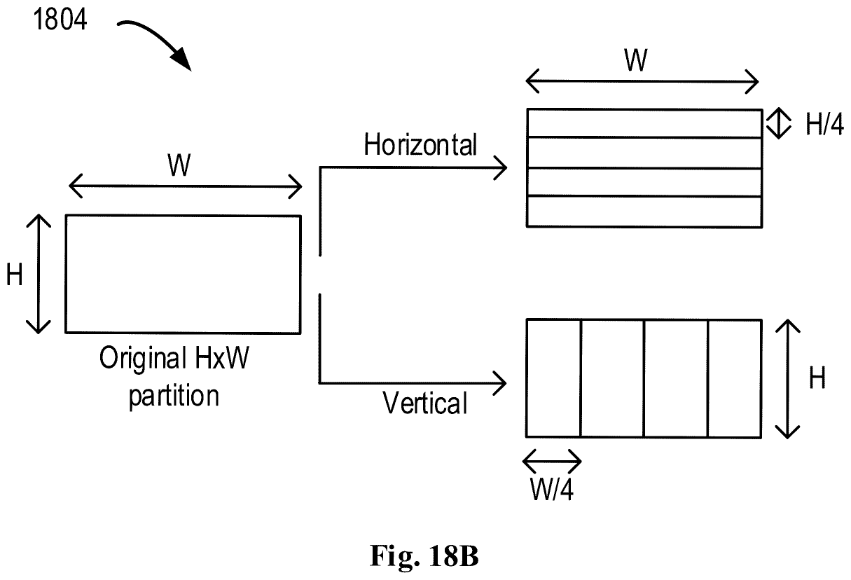

If the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 18A-18B show examples of the two possibilities. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-5
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-5. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
If w=1 or h=1, then there is no horizontal or vertical transform respectively.
If w≥4 and w≤16, t_{H}=DST-VII, otherwise, t_{H}=DCT-II.
If h≥4 and h≤16, t_{V}=DST-VII, otherwise, t_{V}=DCT-II.

In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### 2.15. Matrix Weighted Intra Prediction (MIP)

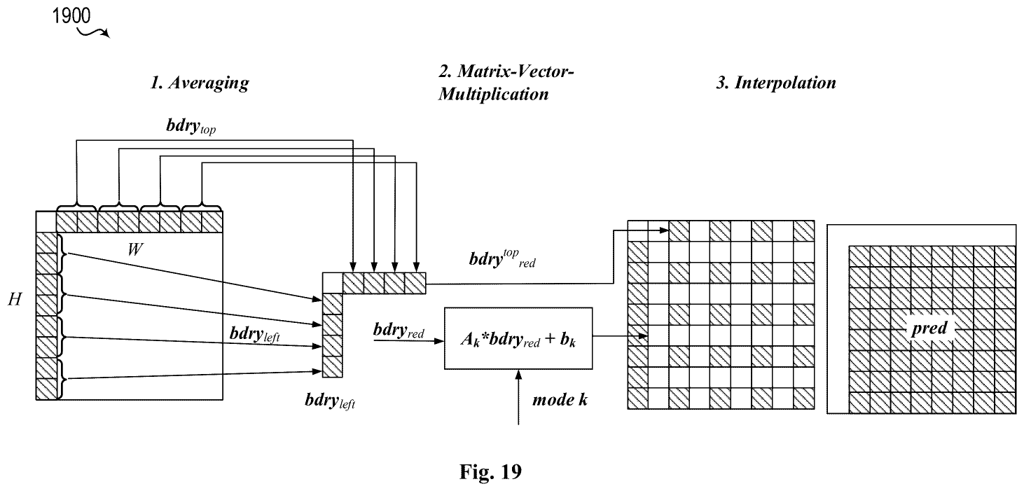

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 19.

### 2.15.1. Averaging Neighbouring Samples

Among the boundary samples, four samples or eight samples are selected by averaging based on block size an shape. Specifically, the input boundaries bdry^{top} and bdry^{left} are reduced to smaller boundaries

$${bdry}_{red}^{top} and {bdry}_{red}^{left}$$

by averaging neighbouring boundary samples according to predefined rule depends on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} , {bdry}_{red}^{left} ] & for W = H = 4 and mode < 18 \\ [ {bdry}_{red}^{left} , {bdry}_{red}^{top} ] & for W = H = 4 and mode \geq 18 \\ [ {bdry}_{red}^{top} , {bdry}_{red}^{left} ] & for max ( W , H ) = 8 and mode < 10 \\ [ {bdry}_{red}^{left} , {bdry}_{red}^{top} ] & for max ( W , H ) = 8 and mode \geq 10 \\ [ {bdry}_{red}^{top} , {bdry}_{red}^{left} ] & for max ( W , H ) > 8 and mode < 6 \\ [ {bdry}_{red}^{left} , {bdry}_{red}^{top} ] & for max ( W , H ) > 8 and mode \geq 6.\end{matrix} \qquad ( 2 - 10 )$$

### 2.15.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$${W}_{r e d} = \{ \begin{matrix}4 & for max ( W , H ) \leq 8 \\ min ( W , 8 ) & for max ( W , H ) > 8\end{matrix} \qquad ( 2 - 11 )$$

$${H}_{r e d} = \{ \begin{matrix}4 & for max ( W , H ) \leq 8 \\ min ( H , 8 ) & for max ( W , H ) > 8\end{matrix} \qquad ( 2 - 12 )$$

The reduced prediction signal pred_{red} is computed by calculating a matrix vector product and adding an offset:

$${pred}_{red} = A \cdot {bdry}_{red} + b . \qquad ( 2 - 13 )$$

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$idx ( W , H ) = \{ \begin{matrix}0 & for W = H = 4 \\ 1 & for max ( W , H ) = 8 \\ 2 & for max ( W , H ) > 8.\end{matrix} \qquad ( 2 - 14 )$$

Here, each coefficient of the matrix A is represented with 8 bit precision. The set S₀ consists of 16 matrices A₀ⁱ, i∈{0, . . . , 15} each of which has 16 rows and 4 columns and 16 offset vectors b₀ⁱ, i∈{0, . . . , 16} each of size 16. Matrices and offset vectors of that set are used for blocks of size 4×4. The set S₁ consists of 8 matrices A₁ⁱ, i∈{0, . . . , 7}, each of which has 16 rows and 8 columns and 8 offset vectors b₁ⁱ, i∈{0, . . . , 7} each of size 16. The set S₂ consists of 6 matrices A₂ⁱ, i∈{0, . . . , 5}, each of which has 64 rows and 8 columns and of 6 offset vectors b₂ⁱ, i∈{0, . . . , 5} of size 64.

### 2.153. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

2.15.4. Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows:

$$isTransposed = predModeIntra \& 1 \qquad ( 2 - 15 )$$

$$modeId = predModeIntra >> 1$$

MIP coding mode is harmonized with other coding tools by considering following aspects:
LFNST is enabled for MIP on large blocks. Here, the LFNST transforms of planar mode are used.
The reference sample derivation for MIP is performed exactly as for the conventional intra prediction modes.
For the up-sampling step used in the MIP-prediction, original reference samples are used instead of down-sampled ones.
Clipping is performed before up-sampling and not after up-sampling.
MIP is allowed up to 64×64 regardless of the maximum transform size.

The number of MIP modes is 32 for sizeId=0, 16 for sizeId=1 and 12 for sizeId=2.

### 2.16. Decoder-Side Intra Mode Derivation

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5˜10% of overall bitrate in all intra coding configuration. This contribution proposes the decoder-side intra mode derivation approach to reduce the intra mode coding overhead while keeping prediction accuracy.

To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

### 2.16.1. Templated Based Intra Mode Derivation

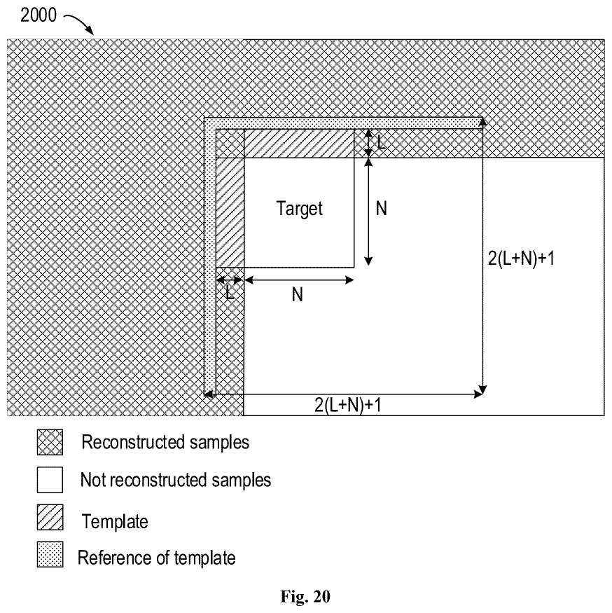

As illustrated in FIG. 20, the target denotes the current block (of block size N) for which intra prediction mode is to be estimated. The template (indicated by the patterned region in FIG. 20) specifies a set of already reconstructed samples, which are used to derive the intra mode. The template size is denoted as the number of samples within the template that extends to the above and the left of the target block, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 20) refers to a set of neighbouring samples from above and left of the template, as defined by JEM-2.0. Unlike the template samples which are always from reconstructed region, the reference samples of template may not be reconstructed yet when encoding/decoding the target block. In this case, the existing reference samples substitution algorithm of JEM-2.0 is utilized to substitute the unavailable reference samples with the available reference samples.

For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target block.

### 2.16.2. DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.

Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode.

Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

### 2.16.3. DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

### 2.16.4. Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.

If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.17. Decoder-Side Intra Mode Derivation by Calculating the Gradients of Neighbouring Samples

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e., throughput of 4×4 blocks). The following sections describe the modifications for each aspect.

### 2.17.1. Signalling

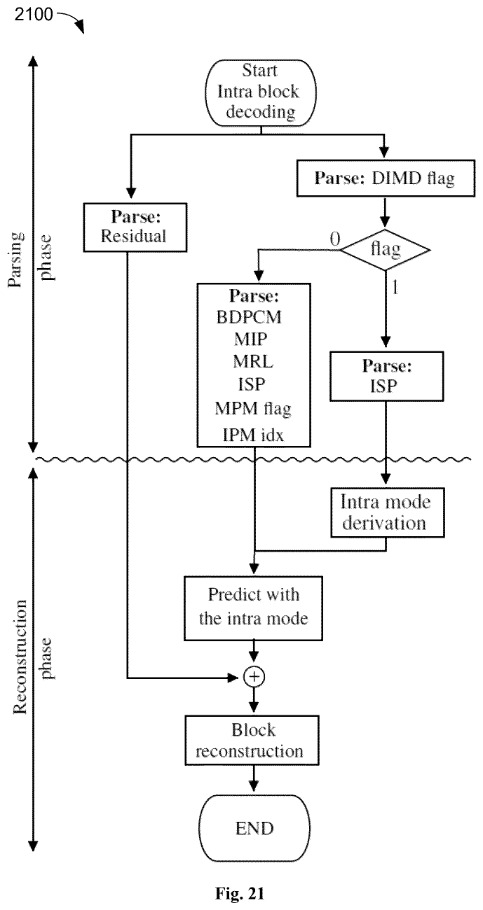

FIG. 21 shows the order of parsing flags/indices in VTM5, integrated with the proposed DIMD.

As can be seen, the DIMD flag of the block is parsed first using a single CABAC context, which is initialized to the default value of 154.

If flag==0, then the parsing continues normally.

Else (if flag==1), only the ISP index is parsed and the following flags/indices are inferred to be zero: BDPCM flag, MIP flag, MRL index. In this case, the entire IPM parsing is also skipped.

During the parsing phase, when a regular non-DIMD block inquires the IPM of its DIMD neighbor, the mode PLANAR_IDX is used as the virtual IPM of the DIMD block.

### 2.17.2. Texture Analysis

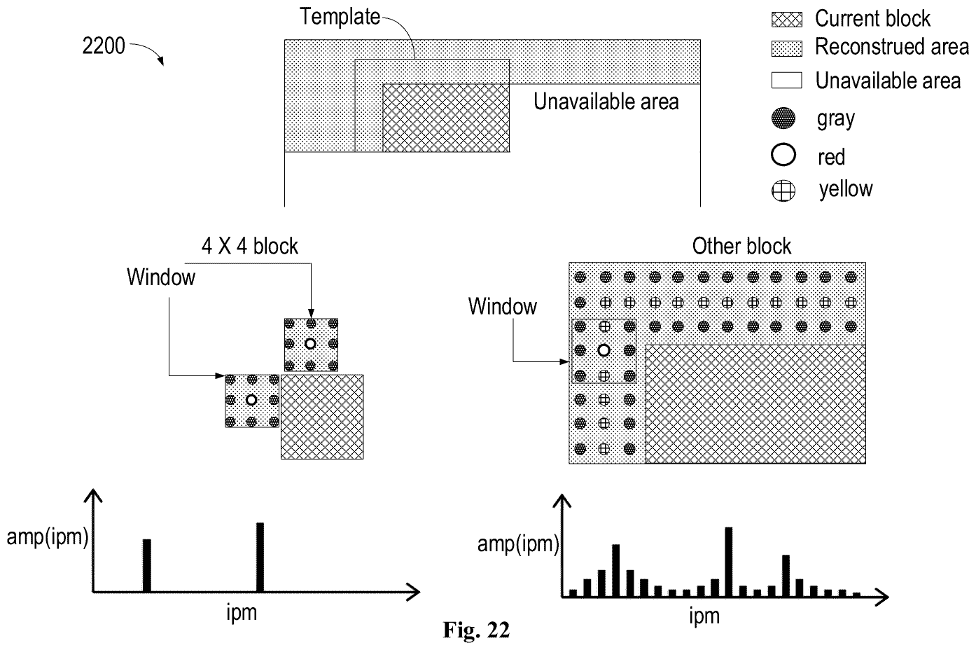

The texture analysis of DIMD includes a Histogram of Gradient (HoG) computation (FIG. 22). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 22. In addition to reduction in the number of operations for gradient computation, this property also simplifies the selection of best 2 modes from the HoG, as the resulting HoG cannot have more than two non-zero amplitudes.

### 2.17.3. Prediction Fusion

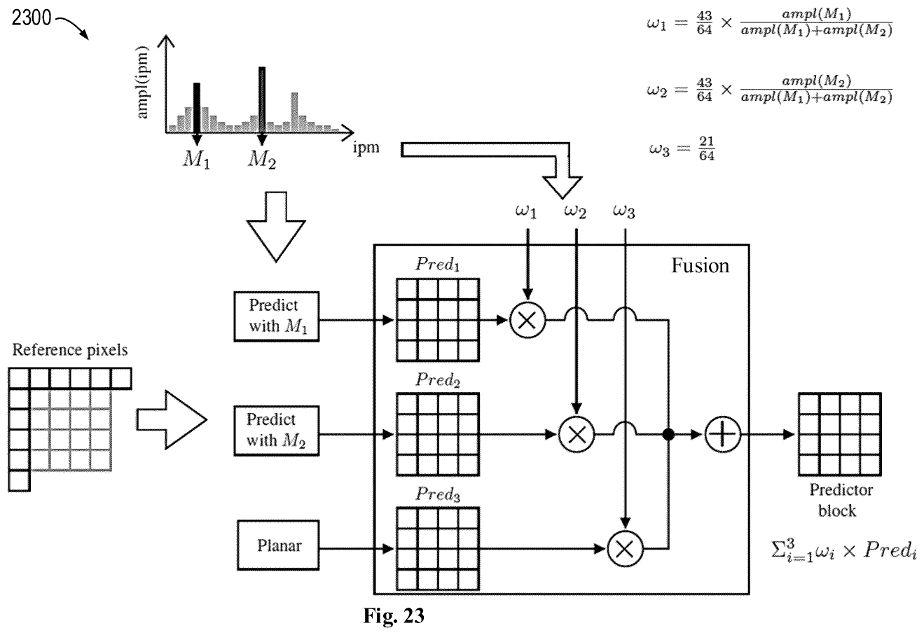

The current method uses a fusion of three predictors for each block. However, the choice of prediction modes is different and makes use of the combined hypothesis intra-prediction method proposed in [2], where the Planar mode is considered to be used in combination with other modes when computing an intra-predicted candidate. In the current version, the two IPMs corresponding to two tallest HoG bars are combined with the Planar mode. The prediction fusion is applied as a weighted average of the above three predictors. To this aim, the weight of planar is fixed to 21/64 (˜1/3). The remaining weight of 43/64 (˜2/3) is then shared between the two HoG IPMs, proportionally to the amplitude of their HoG bars. FIG. 23 visualises this process.

### 2.18. Template-Based Intra Mode Derivation (TIMD)

This contribution proposes a template-based intra mode derivation (TIMD) method using MPMs, in which a TIMD mode is derived from MPMs using the neighbouring template. The TIMD mode is used as an additional intra prediction method for a CU.

### 2.18.1. TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

### 2.18.2. TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

2.18.3. Interaction with New Coding Tools
A DIMD method with prediction fusion using Planar was integrated in EE2. When EE2 DIMD flag is equal to true, the proposed TIMD flag is not signalled and set equal to false.

Similar to PDPC, Gradient PDPC is also included in the derivation of the TIMD mode.

When secondary MPM is enabled, both the primary MPMs and the secondary MPMs are used to derive the TIMD mode.

6-tap interpolation filter is not used in the derivation of the TIMD mode.

### 2.18.4. Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.

2.18.5. TIMD with Fusion

Instead of selecting the only one mode with the smallest SATD cost, this contribution proposes to choose the first two modes with the smallest SATD costs for the intra modes derived using TIMD method and then fuse them with the weights, and such weighted intra prediction is used to code the current CU. The costs of the two selected modes are compared with a threshold, in the test the cost factor of 2 is applied as follows:

$$costMode 2 < {2}^{′} costMode 1.$$

If this condition is true, the fusion is applied, otherwise the only mode1 is used.

Weights of the modes are computed from their SATD costs as follows:

$$weight 1 = costMode 2 / ( costMode 1 + costMode 2 ) , weight 2 = 1 - weight 1.$$

### 2.19. Convolutional Cross-Component Model (CCCM) for Intra Prediction

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma subsampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.19.1. Convolutional Filter

The proposed convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated below in FIG. 24.

The nonlinear term P is represented as power of two of the center luma sample C and scaled to the sample value range of the content:

$$P = ( C * C + midVal ) >> \text{bitDepth.}$$

That is, for 10-bit content it is calculated as:

$$P = ( C * C + 512 ) >> 10.$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.19.2. Calculation of Filter Coefficients

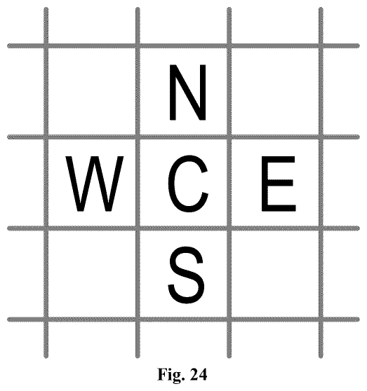

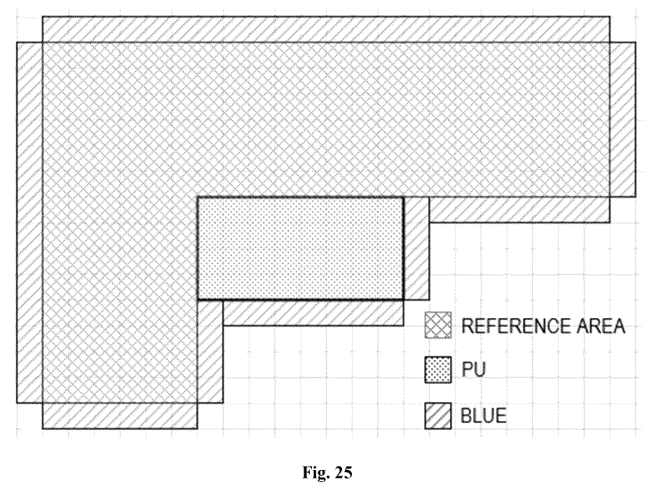

The filter coefficients ci are calculated by minimising MSE between predicted and reconstructed chroma samples in the reference area. FIG. 25 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations. The proposed approach uses only integer arithmetic.

### 2.193. Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA_IDX (to enable single mode CCCM) or MMLM_CHROMA_IDX (to enable multi-model CCCM).

### 2.20. Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

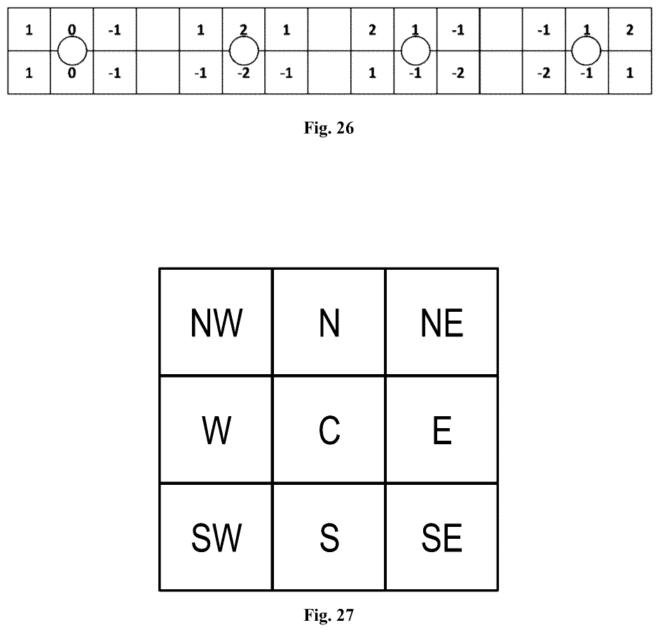

For signaling, when the CCLM mode is enabled to the current CU, two flags are signaled separately for Cb and Cr components to indicate whether GLM is enabled to each component; if the GLM is enabled for one component, one syntax element is further signaled to select one of 4 gradient filters for the gradient calculation.
Four gradient filters are enabled for the GLM, as illustrated in FIG. 26.

### 2.21. Gradient and Location Based Convolutional Cross-Component Model (GL-CCCM) for Intra Prediction

The proposed GL-CCCM method uses gradient and location information instead of the 4 spatial neighbor samples in the CCCM filter. The GL-CCCM filter for the prediction is:

$$predChromaVal = {c}_{0} C + {c}_{1} {G}_{y} + {c}_{2} {G}_{x} + {c}_{3} Y + {c}_{4} X + {c}_{5} P + {c}_{6} B .$$

Where G_{y} and Gₓ are the vertical and horizontal gradients, respectively, and are calculated as:

$${G}_{y} = ( 2 N + N W + N E ) - ( 2 S + S W + S E ) ,$$

$${G}_{x} = ( 2 W + N W + S W ) - ( 2 E + N E + SE ) .$$

Moreover, the Y and X parameters are the vertical and horizontal locations of the center luma sample and they are calculated with respect to the top-left coordinates of the block.

The rest of the parameters are the same as CCCM tool. The reference area for the parameter calculation is the same as CCCM method.

### Bitstream Signalling

Usage of the mode is signalled with a CABAC coded PU level flag. One new CABAC context was included to support this. When it comes to signalling, GL-CCCM is considered a sub-mode of CCCM. That is, the GL-CCCM flag is only signalled if original CCCM flag is true.

### Encoder Operation

The encoder performs two new RD checks in the chroma prediction mode loop, one for checking single model GL-CCCM mode and one for checking multi-model GL-CCCM mode.

### 2.22. CCCM Using Non-Downsampled Luma Samples

### 2.22.1. Block Level

In this contribution, the CCCM using non-downsampled luma samples is proposed where the chroma samples are directly predicted from the original reconstructed luma samples, i.e., without downsampling. As shown in FIG. 28, the proposed CCCM filter consists of 6-tap spatial terms, two nonlinear terms and a bias term. The 6-tap spatial terms correspond to 6 neighboring luma samples (i.e., L₀, L₁, . . . , L₅) to the chroma sample (i.e., C) to be predicted.

$$C = {\sum }_{i = 0}^{5} {α}_{i} \cdot {L}_{i} + {\sum }_{i = 6}^{7} {α}_{i} \cdot ( ( {( {L}_{i - 4} )}^{2} + β ) ≫ bitDepth ) + {α}_{8} \cdot β$$

where αᵢ is the coefficient associated with Lᵢ and β is the offset. Same to the existing CCCM design, up to 6 lines/columns of chroma samples above and left to the current CU are applied to derive the filter coefficients. The filter coefficients are derived based on the same LDL decomposition method used in CCCM. In the contribution, the proposed method is signaled as one extra CCCM model besides the existing CCCM model. For signaling, when the CCCM is selected, one single flag is signaled and used for both two chroma components to indicate whether the default CCCM model or the proposed CCCM model is applied.

### 2.22.2. High Level Control

Subsampling of luma component may not be optimal for CCCM model derivation for the content which has sharp details, such as SCC content. In this contribution it is proposed to disable luma subsampling, derive and apply model on nonsubsampled luma samples directly. CCCM model shape is diamond 5×5 if subsampling is not applied. SPS flag is signalled to indicate whether luma subsampling is applied for CCCM.

### 2.23. Spatial GPM (SGPM)

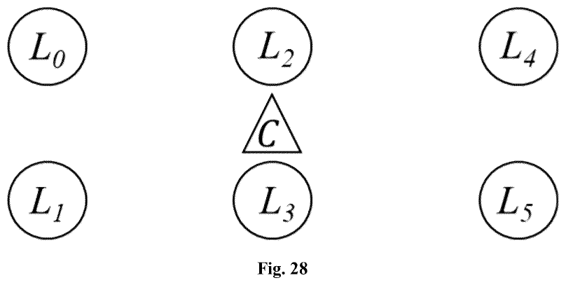

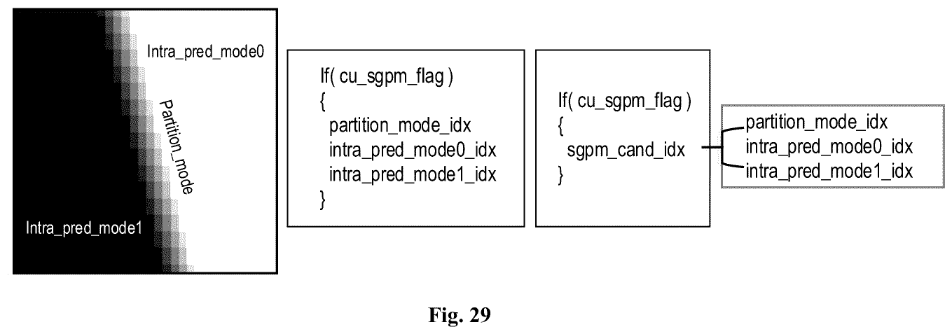

In spatial GPM, a candidate list is built which includes partition split and two intra prediction modes. Up to 11 MPMs of intra prediction modes are used to form the combinations, the length of the candidate list is set equal to 16. The selected candidate index is signalled. FIG. 29 shows spatial GPM candidates.

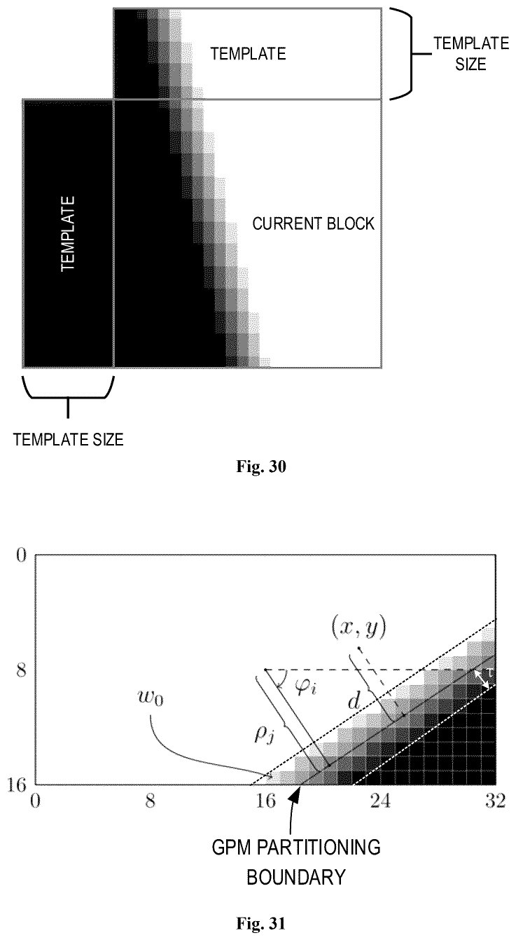

The list is reordered using template shown in FIG. 29. GPM blending process is not used in the template, and SAD between the prediction and reconstruction of the template is used for ordering. FIG. 30 shows GPM template. FIG. 31 shows GPM blending.

The SGPM mode is applied to blocks whose width and height meet the same restrictions as in inter GPM.

The following items are considered:
Spatial GPM partition modes:
   26 predefined modes.
   Adaptive derivation algorithm based on the horizontal and vertical gradients ratio.
Intra prediction mode selection:
   IPM list with and without TIMD:
      For each partition mode, an IPM list is derived for each part using intra-inter GPM list derivation. The IPM list size is 3. In the list, TIMD derived mode is replaced by 2 derived modes with horizontal and vertical orientations (using top or left templates) or TIMD derived mode is excluded.
   MPM list:
      A uniform MPM list, up to 11 elements, is used for all partition modes.
Template size (left and above): 1 or 4
Extended block size:
   Spatial GPM is extended to be further applied to 4×8, 8×4, 4×16 and 16×4 blocks, which can be described as 4<=width<=64, 4<=height<=64, width<height*8, height<width*8, width*height>=32.
Adaptive blending:
   Adaptive blending is tested for spatial GPM, where blending depth τ is derived as follows:
      If min(width, height)==4, ½τ is selected;
      else if min(width, height)==8, τ is selected;
      else if min(width, height)×=16, 2 τ is selected;
      else if min(width, height)×=32, 4 τ is selected;
      else, 8 τ is selected.

### 2.24. Signaling of Cross-Component Prediction Modes in ECM

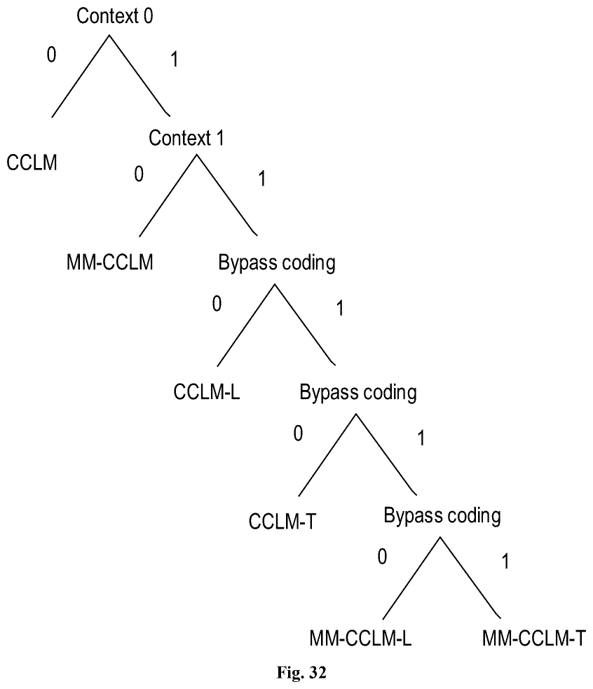

FIG. 32 shows binarization of cross-component prediction modes in ECM. “CCLM” in FIG. 32 may be replaced by “CCCM”.

In ECM-7, cross-components modes include CCLM, CCLM-L, CCLM-T, MM-CCLM, MM-CCLM-L, MM-CCLM-T, and CCCM, CCCM-L, CCCM-T, MM-CCCM, MM-CCCM-L, MM-CCCM-T. One flag is signaled to determine whether it is a kind of CCCM mode or a kind of CCLM mode. A truncated unary code is applied to indicate the CCLM mode or CCCM mode shown in FIG. 32.
CCLM or CCCM: 0;
MM-CCLM or MM-CCCM: 10;
CCLM-L or CCCM-L: 110;
CCLM-T or CCCM-T: 1110;
MM-CCLM-L or MM-CCCM-L: 11110;
MM-CCLM-T or MM-CCCM-T: 11110.

### 3. Problems

1. Cross-component prediction may introduce discontinuity.

2. Signaling of cross-component prediction may not be efficient.

### 4. Detailed Solutions

The solutions below should be considered as examples to explain general concepts. These solutions should not be interpreted in a narrow way. Furthermore, these solutions can be combined in any manner.

In the following discussion, CCCM may refer to the original CCCM mode, or it may refer to a variance of CCCM, such as CCCM-L, CCCM-T, MM-CCCM, MM-CCCM-L, MM-CCCM-T.

In the following discussion, CCLM may refer to the original CCLM mode, or it may refer to a variance of CCLM, such as CCLM-L, CCLM-T, MM-CCLM, MM-CCLM-L, MM-CCLM-T, etc.

### Filtering on Cross-Component Prediction

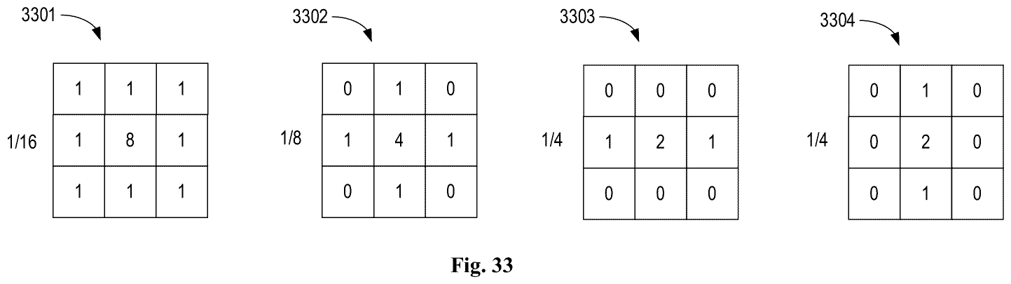

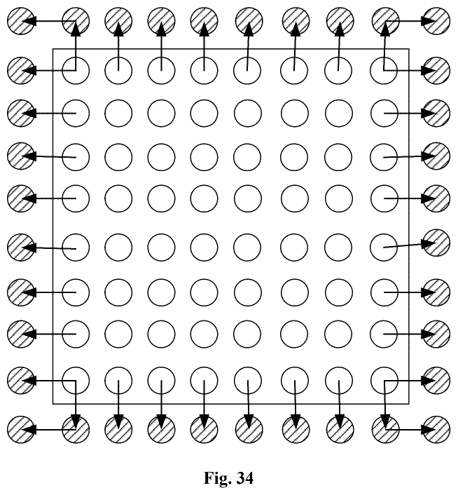

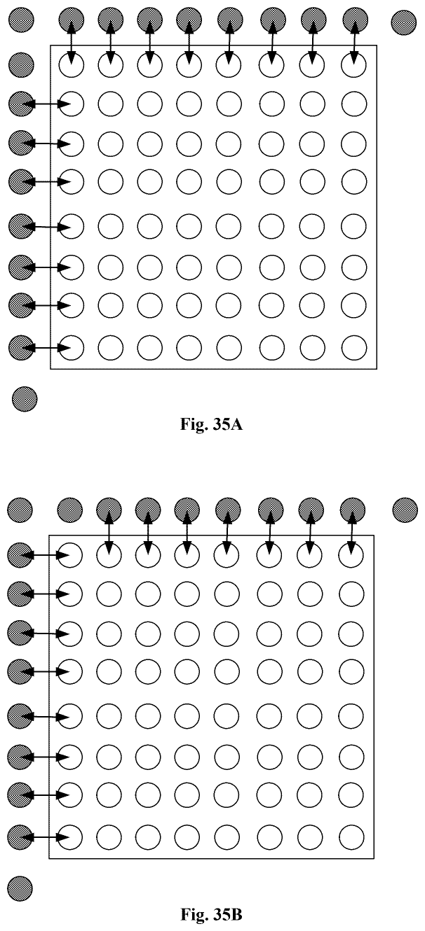

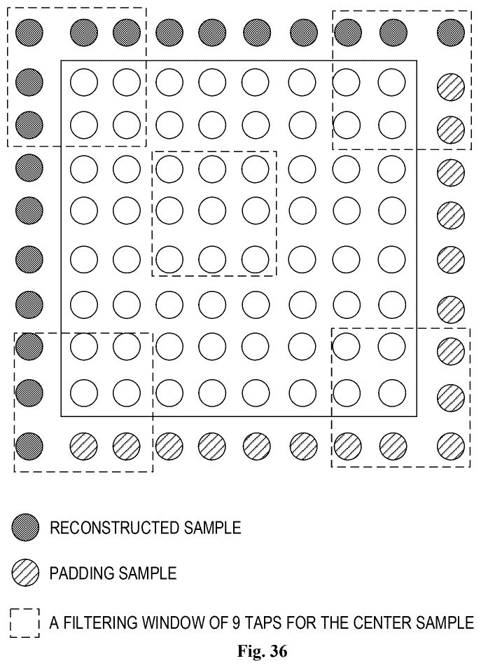

1. It is proposed that cross-component prediction, such as MM-CCLM or MM-CCCM, in a block may be modified before being further processed.
   a. In one example, the cross-component prediction in a block may be filtered before being further processed.
      1) In one example, a prediction sample denoted as F(x, y) after filtering may be derived as a weighted average of n prediction samples denoted as P(x′, y′) before filtering. In an equation way,

$$F ( x , y ) = {\sum }_{k = 0}^{n - 1} {W}_{k} P ( {x}_{k} , {y}_{k} ) ,$$

where Wₖ is the weighting value on the k-th sample.
   a) In one example,

$$F ( x , y ) = ( {\sum }_{k = 0}^{n - 1} {W}_{k} P ( {x}_{k} , {y}_{k} ) + offset ) ≫ S ,$$

wherein Wₖ, offset and S are integers.
2) In one example, F(x,y)=(8P(x,y)+P(x−1,y−1)+P(x,y−1)+P(x+1,y−1)+P(x−1,y)+P(x+1,y)+P(x−1,y+1)+P(x,y+1)+P(x+1,y+1)+8) 4.
3) In one example, F(x, y)=(4P(x,y)+P(x,y−1)+P(x−1,y)+P(x+1,y)+P(x,y+1)+4) 3.
4) In one example, F(x,y)=(2P(x,y)+P(x,y−1)+P(x,y+1)+2) 2.
5) In one example, F(x,y)=(2P(x,y)+P(x−1,y)+P(x+1,y)+2) 2.
6) FIG. 33 shows several examples of the filtering taps.
b. In one example, a same modification approach (such as filtering) may be applied to different colour components such as Cb and Cr.
c. In one example, different modification approaches (such as different filtering methods) may be applied to different colour components such as Cb and Cr.
d. In one example, sample padding may be performed at the block boundary.
   i. For example, a repetition padding may be applied at the boundary. FIG. 34 shows an example of repetition padding. Shaded samples are padded. An “arrow” means “copy”.
e. In one example, filtering may not be performed on a sample where at least one tap sample is out of the current block.
f. In one example, an alternative filtering shape may be applied on a sample where at least one tap sample of the original filtering shape is out of the current block. With the alternative filtering shape, the sample out of the current block is excluded to be a filtering tap sample.
2. It is proposed that the cross-component prediction in a block may be modified depending on at least one reconstructed sample before being further processed.
   a. In one example, a cross-component prediction sample in a block may be filtered with at least one reconstructed sample.
   b. In one example, the reconstructed sample may be an adjacent or non-adjacent neighboring sample.
   c. In one example, the reconstructed sample may be a temporal reference sample in a reference block.
   d. In one example, the reconstructed sample may be with the same colour component or with a different colour component.
   e. In one example, the top N (e.g. N=1) rows of samples of the current block may be filtered with the neighbouring reconstructed samples above the current block.
      i. For example, F(x, 0)=(3P(x, 0)+R(x, −1)) 2, where R(x, −1) is a reconstructed sample.
   f. In one example, the top N (e.g. N=1) columns of samples of the current block may be filtered with the neighbouring reconstructed samples left to the current block.
      i. For example, F(0, y)=(3P(0,y)+R(−1,y)) 2, where R(−1, y) is a reconstructed sample.
   g. FIGS. 35A-35B shows two examples of filtering with neighbouring reconstructed samples. An “arrow” means “filtering”
   h. In one example, a prediction sample is filtered with a reconstructed sample only if it is available.
      i. In one example, a prediction sample is filtered with a padding sample if the reconstructed sample is unavailable.
      ii. In one example, a prediction sample is not filtered with the tap associated with the reconstruction sample if the reconstructed sample is unavailable.
   i. In one example, a prediction sample may be filtered with a reconstructed sample and/or a prediction sample, and/or a padding sample.
   j. FIG. 36 shows an example of filtering on a prediction block. The filtering widow is 3×3 as shown in FIG. 33. Reconstructed samples, prediction samples, and padding samples may be involved in the filtering process for a sample, depending on the sample position.
3. In one example, a modified (such as filtered) prediction sample may be used to modify (such as filter) another prediction sample that has not been modified (such as filtered).
4. In one example, position dependent prediction combination (PDPC) may be applied to a chroma intra coding block.
   a. PDPC is applied if the block is coded with a cross-component prediction mode.
5. In one example, whether to modify (such as filter) the cross-component prediction in a block may be signaled as a syntax element (SE).
   a. For example, the SE is signaled in a conditional way.
      i. E.g., the SE is signaled only if the mode of the current block is a cross-component prediction mode.
      ii. E.g., the SE is signaled only if the mode of the current block is MM-CCLM or MM-CCCM.
      iii. E.g., the SE is signaled only if the mode of the current block is MM-CCLM, MM-CCLM-L, MM-CCLM-T or MM-CCCM, MM-CCCM-T, MM-CCCM-L.
6. In one example, the cross-component prediction may be modified (such as filtering) when the cross-component prediction is used in a fusion mode.
   a. With the fusion mode, a prediction value may be generated by at least two prediction methods, at least one of them is cross-component prediction, such as CCLM or CCCM.

### More Fusion Modes of Cross-Component Prediction

7. It is proposed that a prediction value may be generated by at least two prediction methods, at least one of them is cross-component prediction, such as CCLM or CCCM and at least one of them is inter-prediction.
   a. In one example, the prediction value may be generated as a weighted sum of the at least two prediction methods.
   b. In one example, a prediction value of a chroma block may be generated by at least two prediction methods, at least one of them is cross-component prediction, such as CCLM or CCCM or MM-CCLM or MM-CCCM and at least one of them is inter-prediction when the block is coded with combined inter-intra prediction (CIP) mode.
8. It is proposed that a prediction value may be generated by at least two prediction methods, at least two of them are cross-component predictions, such as CCLM or CCCM.
   a. In one example, the prediction value may be generated as a weighted sum of the at least two prediction methods.
   b. The two prediction methods may be any combination of {CCLM, MM-CCLM, CCLM-L, CCLM-T, MM-CCLM-L, MM-CCLM-T, CCCM, MM-CCCM, CCCM-L, CCCM-T, MM-CCCM-L, MM-CCCM-T}.
9. It is proposed that the SGPM may be applied on a chroma component, such as Cb/Cr.
   a. In one example, the splitting method (or the weighting method) may be the same for Cb and Cr.
   b. In one example, the splitting method (or the weighting method) may be different for Cb and Cr.
   c. In one example, the splitting method (or the weighting method) of Cb and/or Cr may share the same one as luma.
   d. In one example, the splitting method (or the weighting method) of Cb and/or Cr may be different from that of luma.
      i. The splitting method (or the weighting method) of Cb and/or Cr may be signaled with at least one syntax element (SE).
      ii. The splitting method (or the weighting method) of Cb and/or Cr may be derived without signaling a SE.
   e. In one example, at least one prediction method used in SGPM for chroma may be cross-component prediction, such as CCLM/CCCM/MM-CCLM/MM-CCCM/etc.

### Signaling of Cross-Component Prediction

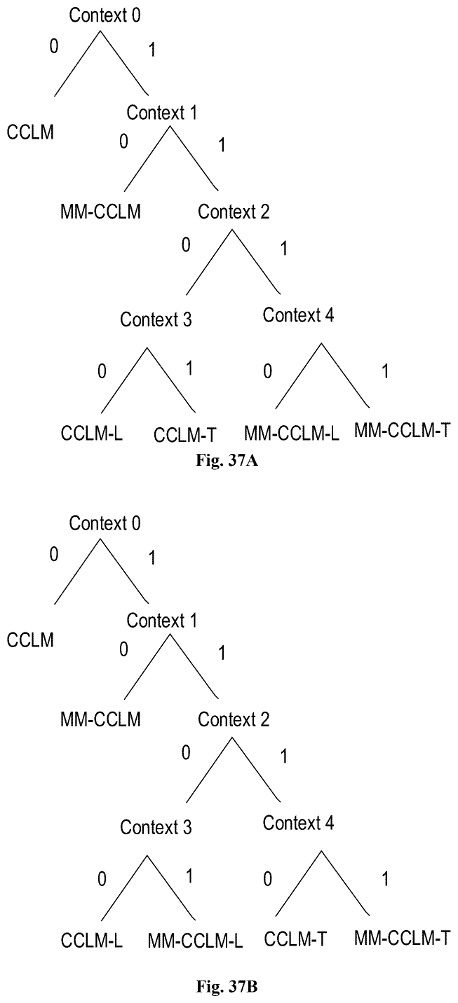

10. It is proposed that CCLM-L, CCLM-T, MM-CCLM-L and MM-CCLM-T (or CCCM-L, CCCM-T, MM-CCCM-L and MM-CCCM-T) may be signaled in a way different from truncated unary coding.
   a. In one example, a first flag may be signaled to indicate whether left mode (CCLM-L, MM-CCLM-L or CCCM-L, MM-CCCM-L) or above mode (CCLM-T, MM-CCLM-T or CCCM-T, MM-CCCM-T) is used.
   b. In one example, a second flag may be signaled to indicate whether a single model mode (CCLM-L, CCLM-T or CCCM-L, CCCM-T) or a multiple model mode (MM-CCLM-L, MM-CCLM-T or MM-CCCM-L, MM-CCCM-T) is used.
   c. In one example, the first or second flag may be coded with at least one context model.
      i. In one example, the context model may be determined by coding information of neighbouring blocks, such as mode information of neighbouring blocks.
      ii. In one example, the context model for the second flag may depend on the first flag.
      iii. In one example, the context model for the first flag may depend on the second flag.
   d. In one example, the first or second flag may be coded with bypass coding.
   e. In one example, the first flag may be coded before the second flag.
   f. In one example, the second flag may be coded before the first flag.
   g. FIGS. 37A-37B show two examples of the proposed coding tree. “CCLM” in the FIGS. 37A-37B may be replaced by “CCCM”.
   h. In one example, the first or second flag may be signaled in a conditional way.
      i. The first or second flag is signaled only if it is indicated that the mode is CCLM-L, CCLM-T, MM-CCLM-L and MM-CCLM-T (or CCCM-L, CCCM-T, MM-CCCM-L and MM-CCCM-T).
      ii. The first flag is signaled only if both the left and the above neighbouring blocks are available.
      iii. The second flag is signaled only if either the left or the above neighbouring blocks are available.

### General Aspects

11. A syntax element disclosed above may be binarized as a flag, a fixed length code, an EG(x) code, a unary code, a truncated unary code, a truncated binary code, etc. It can be signed or unsigned.
12. A syntax element disclosed above may be coded with at least one context model. Or it may be bypass coded.
13. A syntax element disclosed above may be signaled in a conditional way.
   a. The SE is signaled only if the corresponding function is applicable.
14. A syntax element disclosed above may be signaled at block level/sequence level/group of pictures level/picture level/slice level/tile group level, such as in coding structures of CTU/CU/TU/PU/CTB/CB/IB/PB, or sequence header/picture header/SPS/VPS/DPS/DCI/PPS/APS/slice header/tile group header.
15. Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
16. Whether to and/or how to apply the disclosed methods above may be dependent on coded information, such as block size, colour format, single/dual tree partitioning, colour component, slice/picture type.
17. The proposed methods disclosed in this document may be used in other coding tools which require chroma fusion.

More details of the embodiments of the present disclosure will be described below which are related to cross-component prediction. The embodiments of the present disclosure should be considered as examples to explain the general concepts and should not be interpreted in a narrow way. Furthermore, these embodiments can be applied individually or combined in any manner.

As used herein, the term “block” may represent a color component, a sub-picture, a picture, a slice, a tile, a coding tree unit (CTU), a CTU row, groups of CTU, a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

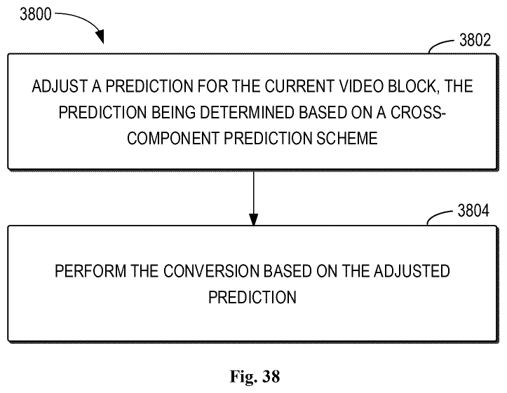

FIG. 38 illustrates a flowchart of a method 3800 for video processing in accordance with some embodiments of the present disclosure. The method 3800 may be implemented during a conversion between a current video block of a video and a bitstream of the video. As shown in FIG. 38, the method 3800 starts at 3802 where a prediction for the current video block is adjusted. The prediction is determined based on a cross-component prediction scheme.

In some embodiments, the prediction for the current video block may be adjusted by filtering the prediction. Alternatively, the prediction for the current video block may be adjusted by upsampling the prediction. In some embodiments, the prediction for the current video block may be adjusted by downsampling the prediction. It should be understood that the possible implementations of the adjustment described here are merely illustrative and therefore should not be construed as limiting the present disclosure in any way.

In some embodiments, the cross-component prediction scheme may comprise a cross-component linear model (CCLM) and/or a variance of CCLM, such as, a multi-model CCLM (MM-CCLM), CCLM left (CCLM-L), CCLM top (CCLM-T), MM-CCLM-L, MM-CCLM-T, or the like. Additionally or alternatively, the cross-component prediction scheme may comprise a convolutional cross-component model (CCLM) and/or a variance of CCCM, such as, a multi-model CCCM (MM-CCCM), CCCM left (CCCM-L), CCCM top (CCCM-T), MM-CCCM-L, MM-CCCM-T, or the like.

At 3804, the conversion is performed based on the adjusted prediction. In some embodiments, the conversion may include encoding the current video block into the bitstream. Alternatively or additionally, the conversion may include decoding the current video block from the bitstream. It should be understood that the above illustrations and/or examples are described merely for purpose of description. The scope of the present disclosure is not limited in this respect.

In view of the above, a prediction for a video block determined based on a cross-component prediction scheme is adjusted before being further processed. Compared with the conventional solution, the proposed method can advantageously improve the coding quality.

In some embodiments, the prediction for the current video block may comprise a first prediction sample, and the adjusted prediction may comprise the filtered first prediction sample, which is obtained by filtering the first prediction sample. By way of example rather than limitation, the filtered first prediction sample may be determined based on a weighted sum of a plurality of prediction samples in the prediction for the current video block. In aid of the filtering process described herein, the discontinuity introduced by the cross-component prediction scheme may be reduced, and thus the coding quality may be improved.

In one example embodiment, the filtered first prediction sample may be determined based on the following:

$$F ( x , y ) = {\sum }_{k = 0}^{L - 1} {W}_{k} P ( {x}_{k} , {y}_{k} )$$

where F(x, y) represents the filtered first prediction sample that is at a coordinate (x, y), L represents the number of the plurality of prediction samples, P(xₖ, yₖ) represents a k-th prediction sample in the plurality of prediction samples, and Wₖ represents a weighting value for the k-th prediction sample.

In another example embodiment, the filtered first prediction sample may be determined based on the following:

$$F ( x , y ) = ( {\sum }_{k = 0}^{L - 1} {W}_{k} P ( {x}_{k} , {y}_{k} ) + offset ) ≫ S$$

where F(x, y) represents the filtered first prediction sample that is at a coordinate (x, y), L represents the number of the plurality of prediction samples, P(xₖ, yₖ) represents a k-th prediction sample in the plurality of prediction samples, Wₖ represents a weighting value for the k-th prediction sample, each of offset and S may be an integer.

In one example, the filtered first prediction sample may be determined based on the following:

$$F ( x , y ) = ( 8 P ( x , y ) + P ( x - 1 , y - 1 ) + P ( x , y - 1 ) + P ( x + 1 , y - 1 ) + P ( x - 1 , y ) + P ( x + 1 , y ) + P ( x - 1 , y + 1 ) + P ( x , y + 1 ) + P ( x + 1 , y + 1 ) + 8 ) ≫ 4$$

where F(x, y) represents the filtered first prediction sample that is at a coordinate (x, y), and P(s, t) represents a prediction sample in the plurality of prediction samples that is at a coordinate (s, t).

In another example, the filtered first prediction sample may be determined based on the following:

$$F ( x , y ) = ( 4 P ( x , y ) + P ( x , y - 1 ) + P ( x - 1 , y ) + P ( x + 1 , y ) + P ( x , y + 1 ) + 4 ) >> 3$$

where F(x, y) represents the filtered first prediction sample that is at a coordinate (x, y), and P(s, t) represents a prediction sample in the plurality of prediction samples that is at a coordinate (s, t).

In a further example, the filtered first prediction sample may be determined based on the following:

$$F ( x , y ) = ( 2 P ( x , y ) + P ( x , y - 1 ) + P ( x , y + 1 ) + 2 ) >> 2$$

where F(x, y) represents the filtered first prediction sample that is at a coordinate (x, y), and P(s, t) represents a prediction sample in the plurality of prediction samples that is at a coordinate (s, t).

In a still further example, the filtered first prediction sample may be determined based on the following:

$$F ( x , y ) = ( 2 P ( x , y ) + P ( x - 1 , y ) + P ( x + 1 , y ) + 2 ) >> 2$$

where F(x, y) represents the filtered first prediction sample that is at a coordinate (x, y), and P(s, t) represents a prediction sample in the plurality of prediction samples that is at a coordinate (s, t).

In some embodiments, a shape of a filter for filtering the prediction may be a square, as shown in subfigure 3301 of FIG. 33. Alternatively, the shape of a filter for filtering the prediction may be a cross, as shown in subfigure 3302 of FIG. 33. In some further embodiments, the shape of a filter for filtering the prediction may be a vertical line, as shown in subfigure 3303 of FIG. 33. In some still further embodiments, the shape of a filter for filtering the prediction may be a horizontal line, as shown in subfigure 3304 of FIG. 33.

In some embodiments, different color components of the current video block may be adjusted based on a same adjusting scheme (such as filtering). Alternatively, different color components of the current video block may be adjusted based on different adjusting schemes (such as different filter schemes). By way of example rather than limitation, the different color components may comprise a Cb component and a Cr component. For example, the Cb component may represent a blue-difference chroma component and the Cr component may represent a red-difference chroma component. In another example, Cb and Cr components may be substituted by U and V components. It should be understood that the Cb component and/or the Cr component may represent any other suitable color component. The scope of the present disclosure is not limited in this respect.

In some embodiments, a padding process may be applied on at least one sample at a boundary of the current video block. By way of example, the padding process may comprise a repetition padding. In the repetition padding, a value for one of the at least one sample may be determined to be a value for a sample (such as, the nearest sample or the like) in the current video block. It should be understood that any other suitable padding process (e.g., mirrored padding or the like) may also be applied.

In some embodiments, if at least one sample for filtering a second sample in the current video block is out of the current video block, the second sample may be not filtered. Alternatively, if at least one sample for a filter shape used to filter the second sample in the current video block is out of the current video block, a further filter shape may be used to filter the second sample. In this case, if one or more samples for the further filter shape is out of the current video block, the one or more samples may be excluded from may be used.

In some embodiments, the prediction for the current video block may be adjusted based on at least one reconstructed sample of at least one neighboring block of the current video block. For example, the prediction for the current video block may be adjusted by filtering the prediction with the at least one reconstructed sample.

In some embodiments, one of the at least one reconstructed sample may be adjacent to the current video block. Additionally or alternatively, one of the at least one reconstructed sample may be non-adjacent to the current video block. In some further embodiments, one of the at least one reconstructed sample may be a temporal reference sample in a reference block of the current video block.

In some embodiments, the at least one reconstructed may be of a same color component as a prediction sample to be adjusted. Alternatively, the at least one reconstructed may be of a color component different from the prediction sample to be adjusted.

In some embodiments, the at least one reconstructed sample may comprise neighboring reconstructed samples above the current video block. Moreover, top N rows of prediction samples of the current video block may be filtered with the neighboring reconstructed samples. N may be an integer, such as 1, 2, or the like.

For example, a top one row (e.g., the uppermost row) of prediction samples of the current video block may comprise a third prediction sample, and the third prediction sample may be filtered based on the following:

$$F ( x , 0 ) = ( 3 P ( x , 0 ) + R ( x , - 1 ) ) >> 2$$

where F(x, 0) represents the filtered third prediction sample that is at a coordinate (x, 0), P(x, 0) represents the third prediction sample, and R(x, −1) represents a neighboring reconstructed sample above the third prediction sample.

In some embodiments, the at least one reconstructed sample may comprise neighboring reconstructed samples left to the current video block. Moreover, top M columns of prediction samples of the current video block may be filtered with the neighboring reconstructed samples. M may be an integer, such as 1, 2, or the like.

In some embodiments, a top one column (e.g., the most left column) of prediction samples of the current video block may comprise a fourth prediction sample, and the fourth prediction sample may be filtered based on the following:

$$F ( 0 , y ) = ( 3 P ( 0 , y ) + R ( - 1 , y ) ) >> 2$$

where F(0, y) represents the filtered fourth prediction sample that is at a coordinate (0, y), P(0, y) represents the fourth prediction sample, and R(−1, y) represents a neighboring reconstructed sample left to the fourth prediction sample.

In some embodiments, if a first reconstructed sample in the at least one reconstructed sample is available, a prediction sample of the current video block may be filtered with first reconstructed sample.

If the first reconstructed sample is unavailable, the prediction sample of the current video block may be filtered without the first reconstructed sample. In this case, the prediction sample of the current video block may be filtered with a padding sample rather than the first reconstructed sample.

In some embodiments, a prediction sample of the current video block may be filtered with a reconstructed sample, a further prediction sample, and/or a padding sample, as shown in FIG. 36. In FIG. 36, the hollow circles may represent predicted samples of the current video block. For example, a prediction sample of the current video block may be filtered with a reconstructed sample, a further prediction sample, and/or a padding sample based on a position of the prediction sample.

In some embodiments, the bitstream may comprise a syntax element indicating whether to adjust the prediction for the current video block. Alternatively, a syntax element indicating whether to adjust the prediction for the current video block may be indicated in the bitstream in a conditional way. In one example, if a mode of the current video block comprises a cross-component prediction mode, the syntax element may be indicated in the bitstream.

Alternatively, the syntax element may be indicated in the bitstream if a mode of the current video block comprises one of the following: a multi-model cross-component linear model (MM-CCLM), or a multi-model convolutional cross-component model (MM-CCCM). In a further example, the syntax element may be indicated in the bitstream if a mode of the current video block comprises one of the following: an MM-CCLM, an MM-CCLM-L, an MM-CCLM-T, an MM-CCCM, an MM-CCCM-T, or an MM-CCCM-L. It should be understood that the above examples are described merely for purpose of description. The scope of the present disclosure is not limited in this respect.

In some embodiments, if the prediction for the current video block is used in a fusion mode, the prediction for the current video block may be adjusted. For example, a target prediction for the current video block may be determined in the fusion mode by fusing the adjusted prediction and at least one further prediction for the current video block. By way of example rather than limitation the at least one further prediction may be determined based on one or more prediction schemes different from the cross-component prediction scheme.

In some embodiments, an adjusted prediction sample in the adjusted prediction for the current video block may be used to adjust a further prediction sample. In some further embodiments, a first video block of the video may be a chroma intra coding block, and a position dependent prediction combination (PDPC) may be applied on the chroma intra coding block. In addition, the first video block may be coded with a cross-component prediction scheme. That is, PDPC is applied if the block is coded with a cross-component prediction mode.

In some embodiments, a target prediction for a second video block of the video may be generated based on a plurality of prediction schemes. By way of example rather than limitation, the target prediction for the second video block may be generated based on a weighted sum of a plurality of candidate predictions for the second video block. The plurality of candidate predictions may be determined based on the plurality of prediction schemes.

In some embodiments, the plurality of prediction schemes may comprise at least one cross-component prediction scheme and at least one inter prediction scheme. Additionally, the second video block may be a chroma block coded with a combined inter-intra prediction (CIIP) mode.

In some alternative embodiments, the plurality of prediction schemes may comprise at least two cross-component prediction schemes. By way of example rather than limitation, the at least two cross-component prediction schemes may comprise a combination of at least two of the following: a CCLM, an MM-CCLM, a CCLM-L, a CCLM-T, an MM-CCLM-L, an MM-CCLM-T, a CCCM, an MM-CCCM, a CCCM-L, a CCCM-T, an MM-CCCM-L, or an MM-CCCM-T.

In some embodiments, a spatial geometric partitioning mode (SGPM) may be applied on at least one chroma component of a third video block of the video. For example, the at least one chroma component may comprise a Cb component and/or a Cr component. Additionally, at least one prediction scheme used in the SGPM may comprise a cross-component prediction scheme.

In some embodiments, a splitting scheme or a weighting scheme of the SGPM for the Cb component may be the same as the Cr component. Alternatively, the splitting scheme or the weighting scheme of the SGPM for the Cb component may be different from the Cr component.

In some embodiments, a splitting scheme or a weighting scheme of the SGPM for one of the at least one chroma component may be the same as a luma component. Alternatively, the splitting scheme or the weighting scheme of the SGPM for one of the at least one chroma component may be different from the luma component.

In some embodiments, the bitstream may comprise at least one syntax element indicating a splitting scheme or a weighting scheme of the SGPM for one of the at least one chroma component. Alternatively, a splitting scheme or a weighting scheme of the SGPM for one of the at least one chroma component may be determined and may be absent from the bitstream.

In some embodiments, a plurality of cross-component prediction schemes may be indicated in the bitstream in a way different from truncated unary coding. In one example, the plurality of cross-component prediction schemes may comprise CCLM-L, CCLM-T, MM-CCLM-L and MM-CCLM-T. In another example, the plurality of cross-component prediction schemes may comprise CCCM-L, CCCM-T, MM-CCCM-L and MM-CCCM-T. It should be understood that the above examples are described merely for purpose of description. The scope of the present disclosure is not limited in this respect.

In some embodiments, the bitstream may comprise at least one of the following: a first indication indicating whether a left mode or an above mode is used, or a second indication indicating whether a single model mode or a multiple model mode is used. The first indication and/or the second indication may be coded with at least one context model. In one example, the at least one context model may be determined based on coding information of a neighboring block of the current video block. Alternatively, a context model for coding the first indication may be dependent on a context model for coding the second indication, or the context model for coding the second indication may be dependent on the context model for coding the first indication.

In some alternative embodiments, the first indication or the second indication may be coded with bypass coding. In some embodiments, the first indication may be coded before the second indication. Alternatively, the second indication may be coded before the first indication.

In some embodiments, each of the first indication and the second indication may be a bit in a bitstring indicating one of the plurality of cross-component prediction schemes. In an example shown in FIG. 37A, CCLM may be indicated by a bitstring 0, MM_CCLM may be indicated by a bitstring 10, CCLM-L may be indicated by a bitstring 1100, CCLM-T may be indicated by a bitstring 1101, MM-CCLM-L may be indicated by a bitstring 1110, and MM-CCLM-T may be indicated by a bitstring 1111.

In this example, the third bit in the bitstring corresponds to the second indication, and the fourth bit in the bitstring corresponds to the first indication.

In a further example shown in FIG. 37B, CCLM may be indicated by a bitstring 0, MM_CCLM may be indicated by a bitstring 10, CCLM-L may be indicated by a bitstring 1100, MM-CCLM-L may be indicated by a bitstring 1101, CCLM-T may be indicated by a bitstring 1110, and MM-CCLM-T may be indicated by a bitstring 1111. In this example, the third bit in the bitstring corresponds to the first indication, and the fourth bit in the bitstring corresponds to the second indication.

In some embodiments, the first indication and/or the second indication may be indicated in the bitstream in a conditional way. For example, if a predetermined cross-component prediction scheme is indicated, the first indication or the second indication may be indicated in the bitstream. By way of example, the first indication or the second indication is signaled only if it is indicated that the mode is CCLM-L, CCLM-T, MM-CCLM-L and MM-CCLM-T (or CCCM-L, CCCM-T, MM-CCCM-L and MM-CCCM-T).

In some embodiments, if both a left neighboring block and an above neighboring block of the current video block are available, the first indication may be indicated in the bitstream. Alternatively, if at least one of a left neighboring block or an above neighboring block of the current video block is available, the second indication may be indicated in the bitstream. In some further embodiments, the first indication and/or the second indication may be implemented as a flag, a syntax element, or the like.

In aid of the above-described signaling method, the signaling of cross-component prediction can be advantageously more efficient than the conventional truncated unary coding scheme.

In some embodiments, a syntax element may be binarized as a flag, a fixed length code, an exponential Golomb (EG) code, a unary code, a truncated unary code, a truncated binary code, or the like. Additionally or alternatively, a syntax element may be signed or unsigned.

In some embodiments, a syntax element may be coded with at least one context model. Alternatively, the syntax element may be bypass coded. In some further embodiments, a syntax element may be indicated in the bitstream in a conditional way. For example, the syntax element may be indicated in the bitstream if a corresponding function is applicable.

In some embodiments, a syntax element may be indicated at a block level, a sequence level, a group of pictures level, a picture level, a slice level, a tile group level, or the like. Additionally or alternatively, a syntax element may be indicated in a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method may be indicated at a block level, a sequence level, a group of pictures level, a picture level, a slice level, a tile group level, or the like. Additionally or alternatively, whether to and/or how to apply the method may be indicated in a coding structure of CTU, a coding structure of CU, a coding structure of TU, a coding structure of PU, a coding structure of CTB, a coding structure of CB, a coding structure of TB, a coding structure of PB, a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method may be dependent on coded information of the current video block. By way of example rather than limitation, the coded information may comprise a block size, a color format, a single tree partitioning, a dual tree partitioning, a color component, a slice type, a picture type, and/or the like. In some further embodiments, the method may be applicable in a coding tool requiring chroma fusion.

It should be understood that the above-mentioned first, second and/or third video block may be the current video block itself, or a further video block different from the current video block. The scope of the present disclosure is not limited in this respect.

According to further embodiments of the present disclosure, a non-transitory computer-readable recording medium is provided. The non-transitory computer-readable recording medium stores a bitstream of a video which is generated by a method performed by an apparatus for video processing. In the method, a prediction for a current video block of the video is adjusted. The prediction is determined based on a cross-component prediction scheme. Moreover, the bitstream is generated based on the adjusted prediction.

According to still further embodiments of the present disclosure, a method for storing bitstream of a video is provided. In the method, a prediction for a current video block of the video is adjusted. The prediction is determined based on a cross-component prediction scheme. Moreover, the bitstream is generated based on the adjusted prediction, and stored in a non-transitory computer-readable recording medium.

Implementations of the present disclosure can be described in view of the following clauses, the features of which can be combined in any reasonable manner.

Clause 1. A method for video processing, comprising: adjusting, for a conversion between a current video block of a video and a bitstream of the video, a prediction for the current video block, the prediction being determined based on a cross-component prediction scheme; and performing the conversion based on the adjusted prediction.

Clause 2. The method of clause 1, wherein the prediction for the current video block is adjusted by filtering the prediction.

Clause 3. The method of clause 2, wherein the prediction for the current video block comprises a first prediction sample, the adjusted prediction comprises the filtered first prediction sample, and the filtered first prediction sample is determined based on a weighted sum of a plurality of prediction samples in the prediction for the current video block.

Clause 4. The method of clause 3, wherein the filtered first prediction sample is determined based on the following:

$$F ( x , y ) = {\sum }_{k = 0}^{L - 1} {W}_{k} P ( {x}_{k} , {y}_{k} )$$

wherein F(x, y) represents the filtered first prediction sample that is at a coordinate (x, y), L represents the number of the plurality of prediction samples, P(xₖ, yₖ) represents a k-th prediction sample in the plurality of prediction samples, and Wₖ represents a weighting value for the k-th prediction sample.

Clause 5. The method of clause 3, wherein the filtered first prediction sample is determined based on the following:

$$F ( x , y ) = ( {\sum }_{k = 0}^{L - 1} {W}_{k} P ( {x}_{k} , {y}_{k} ) + offset ) >> S$$

wherein F(x, y) represents the filtered first prediction sample that is at a coordinate (x, y), L represents the number of the plurality of prediction samples, P(xₖ, yₖ) represents a k-th prediction sample in the plurality of prediction samples, Wₖ represents a weighting value for the k-th prediction sample, each of offset and S is an integer.

Clause 6. The method of clause 3, wherein the filtered first prediction sample is determined based on the following:

$$F ( x , y ) = ( 8 P ( x , y ) + P ( x - 1 , y - 1 ) + P ( x , y - 1 ) + P ( x + 1 , y - 1 ) + P ( x - 1 , y ) + P ( x + 1 , y ) + P ( x - 1 , y + 1 ) + P ( x , y + 1 ) + P ( x + 1 , y + 1 ) + 8 ) >> 4$$

wherein F(x, y) represents the filtered first prediction sample that is at a coordinate (x, y), and P(s, t) represents a prediction sample in the plurality of prediction samples that is at a coordinate (s, t).

Clause 7. The method of clause 3, wherein the filtered first prediction sample is determined based on the following:

$$F ( x , y ) = ( 4 P ( x , y ) + P ( x , y - 1 ) + P ( x - 1 , y ) + P ( x + 1 , y ) + P ( x , y + 1 ) + 4 ) >> 3$$

wherein F(x, y) represents the filtered first prediction sample that is at a coordinate (x, y), and P(s, t) represents a prediction sample in the plurality of prediction samples that is at a coordinate (s, t).

Clause 8. The method of clause 3, wherein the filtered first prediction sample is determined based on the following:

$$F ( x , y ) = ( 2 P ( x , y ) + P ( x , y - 1 ) + P ( x , y + 1 ) + 2 ) >> 2$$

wherein F(x, y) represents the filtered first prediction sample that is at a coordinate (x, y), and P(s, t) represents a prediction sample in the plurality of prediction samples that is at a coordinate (s, t).

Clause 9. The method of clause 3, wherein the filtered first prediction sample is determined based on the following:

$$F ( x , y ) = ( 2 P ( x , y ) + P ( x - 1 , y ) + P ( x + 1 , y ) + 2 ) >> 2$$

wherein F(x, y) represents the filtered first prediction sample that is at a coordinate (x, y), and P(s, t) represents a prediction sample in the plurality of prediction samples that is at a coordinate (s, t).

Clause 10. The method of any of clauses 2-5, wherein a shape of a filter for filtering the prediction comprise one of the following: a square, a cross, a vertical line, or a horizontal line.

Clause 11. The method of any of clauses 1-10, wherein different color components of the current video block are adjusted based on a same adjusting scheme.

Clause 12. The method of any of clauses 1-10, wherein different color components of the current video block are adjusted based on different adjusting schemes.

Clause 13. The method of any of clauses 11-12, wherein the different color components comprise a Cb component and a Cr component.

Clause 14. The method of any of clauses 1-13, wherein a padding process is applied on at least one sample at a boundary of the current video block.

Clause 15. The method of clause 14, wherein the padding process comprises a repetition padding.

Clause 16. The method of clause 15, wherein in the repetition padding, a value for one of the at least one sample is determined to be a value for a sample in the current video block.

Clause 17. The method of any of clauses 2-16, wherein if at least one sample for filtering a second sample in the current video block is out of the current video block, the second sample is not filtered.

Clause 18. The method of any of clauses 2-16, wherein if at least one sample for a filter shape used to filter a second sample in the current video block is out of the current video block, a further filter shape is used to filter the second sample.

Clause 19. The method of clause 18, wherein if one or more samples for the further filter shape are out of the current video block, the one or more samples are excluded from being used.

Clause 20. The method of clause 1, wherein the prediction for the current video block is adjusted based on at least one reconstructed sample of at least one neighboring block of the current video block.

Clause 21. The method of clause 20, wherein the prediction for the current video block is adjusted by filtering the prediction with the at least one reconstructed sample.

Clause 22. The method of any of clauses 20-21, wherein one of the at least one reconstructed sample is adjacent to the current video block, or one of the at least one reconstructed sample is non-adjacent to the current video block.

Clause 23. The method of any of clauses 20-22, wherein one of the at least one reconstructed sample is a temporal reference sample in a reference block of the current video block.

Clause 24. The method of any of clauses 20-23, wherein the at least one reconstructed sample is of a same color component as a prediction sample to be adjusted, or the at least one reconstructed sample is of a color component different from the prediction sample to be adjusted.

Clause 25. The method of any of clauses 21-24, wherein the at least one reconstructed sample comprises neighboring reconstructed samples above the current video block, top N rows of prediction samples of the current video block are filtered with the neighboring reconstructed samples, and N is an integer.

Clause 26. The method of clause 25, wherein a top one row of prediction samples of the current video block comprises a third prediction sample, and the third prediction sample is filtered based on the following:

$$F ( x , 0 ) = ( 3 P ( x , 0 ) + R ( x , - 1 ) ) >> 2$$

wherein F(x, 0) represents the filtered third prediction sample that is at a coordinate (x, 0), P(x, 0) represents the third prediction sample, and R(x, −1) represents a neighboring reconstructed sample above the third prediction sample.

Clause 27. The method of any of clauses 21-26, wherein the at least one reconstructed sample comprises neighboring reconstructed samples left to the current video block, top M columns of prediction samples of the current video block are filtered with the neighboring reconstructed samples, and M is an integer.

Clause 28. The method of clause 27, wherein a top one column of prediction samples of the current video block comprises a fourth prediction sample, and the fourth prediction sample is filtered based on the following:

$$F ( 0 , y ) = ( 3 P ( 0 , y ) + R ( - 1 , y ) ) >> 2$$

wherein F(0, y) represents the filtered fourth prediction sample that is at a coordinate (0, y), P(0, y) represents the fourth prediction sample, and R(−1, y) represents a neighboring reconstructed sample left to the fourth prediction sample.

Clause 29. The method of any of clauses 21-28, wherein if a first reconstructed sample in the at least one reconstructed sample is available, a prediction sample of the current video block is filtered with first reconstructed sample, or if the first reconstructed sample is unavailable, the prediction sample of the current video block is filtered without the first reconstructed sample.

Clause 30. The method of clause 29, wherein if the first reconstructed sample is unavailable, the prediction sample of the current video block is filtered with a padding sample.

Clause 31. The method of clause 2, wherein a prediction sample of the current video block is filtered with at least one of the following: a reconstructed sample, a further prediction sample, or a padding sample.

Clause 32. The method of clause 2, wherein a prediction sample of the current video block is filtered with at least one of the following based on a position of the prediction sample: a reconstructed sample, a further prediction sample, or a padding sample.

Clause 33. The method of any of clauses 1-32, wherein the bitstream comprises a syntax element indicating whether to adjust the prediction for the current video block.

Clause 34. The method of any of clauses 1-32, wherein a syntax element indicating whether to adjust the prediction for the current video block is indicated in the bitstream in a conditional way.

Clause 35. The method of clause 34, wherein if a mode of the current video block comprises a cross-component prediction mode, the syntax element is indicated in the bitstream.

Clause 36. The method of clause 34, wherein the syntax element is indicated in the bitstream if a mode of the current video block comprises one of the following: a multi-model cross-component linear model (MM-CCLM), or a multi-model convolutional cross-component model (MM-CCCM).

Clause 37. The method of clause 34, wherein the syntax element is indicated in the bitstream if a mode of the current video block comprises one of the following: an MM-CCLM, an MM-CCLM-L, an MM-CCLM-T, an MM-CCCM, an MM-CCCM-T, or an MM-CCCM-L.

Clause 38. The method of any of clauses 1-32, wherein if the prediction for the current video block is used in a fusion mode, the prediction for the current video block is adjusted.

Clause 39. The method of clause 38, wherein a target prediction for the current video block is determined in the fusion mode by fusing the adjusted prediction and at least one further prediction for the current video block.

Clause 40. The method of any of clauses 1-39, wherein an adjusted prediction sample in the adjusted prediction for the current video block is used to adjust a further prediction sample.

Clause 41. The method of any of clauses 1-40, wherein a first video block of the video is a chroma intra coding block, and a position dependent prediction combination (PDPC) is applied on the chroma intra coding block.

Clause 42. The method of clause 41, wherein the first video block is coded with a cross-component prediction scheme.

Clause 43. The method of any of clauses 1-42, wherein a target prediction for a second video block of the video is generated based on a plurality of prediction schemes.

Clause 44. The method of clause 43, wherein the target prediction for the second video block is generated based on a weighted sum of a plurality of candidate predictions for the second video block that are determined based on the plurality of prediction schemes.

Clause 45. The method of any of clauses 43-44, wherein the plurality of prediction schemes comprises at least one cross-component prediction scheme and at least one inter prediction scheme.

Clause 46. The method of any of clauses 45, wherein the second video block is a chroma block coded with a combined inter-intra prediction (CIIP) mode.

Clause 47. The method of any of clauses 43-44, wherein the plurality of prediction schemes comprises at least two cross-component prediction schemes.

Clause 48. The method of clause 47, wherein the at least two cross-component prediction schemes comprises a combination of at least two of the following: a CCLM, an MM-CCLM, a CCLM-L, a CCLM-T, an MM-CCLM-L, an MM-CCLM-T, a CCCM, an MM-CCCM, a CCCM-L, a CCCM-T, an MM-CCCM-L, or an MM-CCCM-T.

Clause 49. The method of any of clauses 1-48, wherein a spatial geometric partitioning mode (SGPM) is applied on at least one chroma component of a third video block of the video.

Clause 50. The method of clause 49, wherein the at least one chroma component comprises at least one of a Cb component and a Cr component.

Clause 51. The method of clause 50, wherein a splitting scheme or a weighting scheme of the SGPM for the Cb component is the same as the Cr component, or the splitting scheme or the weighting scheme of the SGPM for the Cb component is different from the Cr component.

Clause 52. The method of any of clauses 49-51, wherein a splitting scheme or a weighting scheme of the SGPM for one of the at least one chroma component is the same as a luma component, or the splitting scheme or the weighting scheme of the SGPM for one of the at least one chroma component is different from the luma component.

Clause 53. The method of any of clauses 49-51, wherein the bitstream comprises at least one syntax element indicating a splitting scheme or a weighting scheme of the SGPM for one of the at least one chroma component.

Clause 54. The method of any of clauses 49-51, wherein a splitting scheme or a weighting scheme of the SGPM for one of the at least one chroma component is determined and is absent from the bitstream.

Clause 55. The method of any of clauses 49-54, wherein at least one prediction scheme used in the SGPM comprises a cross-component prediction scheme.

Clause 56. The method of any of clauses 1-55, wherein a plurality of cross-component prediction schemes are indicated in the bitstream in a way different from truncated unary coding.

Clause 57. The method of clause 56, wherein the plurality of cross-component prediction schemes comprises CCLM-L, CCLM-T, MM-CCLM-L and MM-CCLM-T, or the plurality of cross-component prediction schemes comprises CCCM-L, CCCM-T, MM-CCCM-L and MM-CCCM-T.

Clause 58. The method of any of clauses 56-57, wherein the bitstream comprises at least one of the following: a first indication indicating whether a left mode or an above mode is used, or a second indication indicating whether a single model mode or a multiple model mode is used.

Clause 59. The method of clause 58, wherein the first indication or the second indication is coded with at least one context model.

Clause 60. The method of clause 59, wherein the at least one context model is determined based on coding information of a neighboring block of the current video block.

Clause 61. The method of clause 59, wherein a context model for coding the first indication is dependent on a context model for coding the second indication, or a context model for coding the second indication is dependent on a context model for coding the first indication.

Clause 62. The method of clause 58, wherein the first indication or the second indication is coded with bypass coding.

Clause 63. The method of any of clauses 58-62, wherein the first indication is coded before the second indication, or the second indication is coded before the first indication.

Clause 64. The method of any of clauses 58-62, wherein each of the first indication and the second indication is a bit in a bitstring indicating one of the plurality of cross-component prediction schemes.

Clause 65. The method of any of clauses 56-57, wherein at least one of the following is indicated in the bitstream in a conditional way: a first indication indicating whether a left mode or an above mode is used, or a second indication indicating whether a single model mode or a multiple model mode is used.

Clause 66. The method of clause 65, wherein if a predetermined cross-component prediction scheme is indicated, the first indication or the second indication is indicated in the bitstream.

Clause 67. The method of clause 65, wherein if both a left neighboring block and an above neighboring block of the current video block is available, the first indication is indicated in the bitstream.

Clause 68. The method of clause 65, wherein if at least one of a left neighboring block or an above neighboring block of the current video block is available, the second indication is indicated in the bitstream.

Clause 69. The method of any of clauses 33-37 or 53, wherein a syntax element is binarized as one of the following: a flag, a fixed length code, an exponential Golomb (EG) code, a unary code, a truncated unary code, or a truncated binary code.

Clause 70. The method of any of clauses 33-37, 53, or 69, wherein a syntax element is signed or unsigned.

Clause 71. The method of any of clauses 33-37, 53, or 69-70, wherein a syntax element is coded with at least one context model, or the syntax element is bypass coded.

Clause 72. The method of any of clauses 33-37, 53, or 69-71, wherein a syntax element is indicated in the bitstream in a conditional way.

Clause 73. The method of clause 72, wherein the syntax element is indicated in the bitstream if a corresponding function is applicable.

Clause 74. The method of any of clauses 33-37, 53, or 69-73, wherein a syntax element is indicated at one of the following: a block level, a sequence level, a group of pictures level, a picture level, a slice level, or a tile group level.

Clause 75. The method of any of clauses 33-37, 53, or 69-73, wherein a syntax element is indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 76. The method of any of clauses 1-75, wherein whether to and/or how to apply the method is indicated at one of the following: a block level, a sequence level, a group of pictures level, a picture level, a slice level, or a tile group level.

Clause 77. The method of any of clauses 1-75, wherein whether to and/or how to apply the method is indicated in one of the following: a coding structure of CTU, a coding structure of CU, a coding structure of TU, a coding structure of PU, a coding structure of CTB, a coding structure of CB, a coding structure of TB, a coding structure of PB, a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 78. The method of any of clauses 1-77, wherein whether to and/or how to apply the method is dependent on coded information of the current video block.

Clause 79. The method of clause 78, wherein the coded information comprises at least one of the following: a block size, a color format, a single tree partitioning, a dual tree partitioning, a color component, a slice type, or a picture type.

Clause 80. The method of any of clauses 1-79, wherein the method is applicable in a coding tool requiring chroma fusion.

Clause 81. The method of any of clauses 1-80, wherein the conversion includes encoding the current video block into the bitstream.

Clause 82. The method of any of clauses 1-80, wherein the conversion includes decoding the current video block from the bitstream.

Clause 83. An apparatus for video processing comprising a processor and a non-transitory memory with instructions thereon, wherein the instructions upon execution by the processor, cause the processor to perform a method in accordance with any of clauses 1-82.

Clause 84. A non-transitory computer-readable storage medium storing instructions that cause a processor to perform a method in accordance with any of clauses 1-82.

Clause 85. A non-transitory computer-readable recording medium storing a bitstream of a video which is generated by a method performed by an apparatus for video processing, wherein the method comprises: adjusting a prediction for a current video block of the video, the prediction being determined based on a cross-component prediction scheme; and generating the bitstream based on the adjusted prediction.

Clause 86. A method for storing a bitstream of a video, comprising: adjusting a prediction for a current video block of the video, the prediction being determined based on a cross-component prediction scheme; generating the bitstream based on the adjusted prediction; and storing the bitstream in a non-transitory computer-readable recording medium.

### Example Device

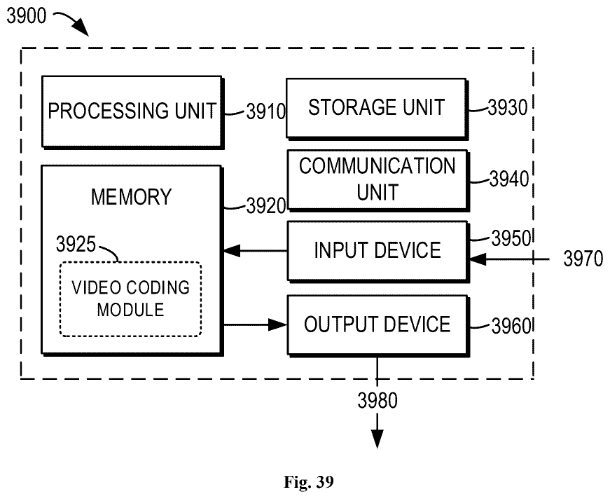

FIG. 39 illustrates a block diagram of a computing device 3900 in which various embodiments of the present disclosure can be implemented. The computing device 3900 may be implemented as or included in the source device 110 (or the video encoder 114 or 200) or the destination device 120 (or the video decoder 124 or 300).

It would be appreciated that the computing device 3900 shown in FIG. 39 is merely for purpose of illustration, without suggesting any limitation to the functions and scopes of the embodiments of the present disclosure in any manner.

As shown in FIG. 39, the computing device 3900 includes a general-purpose computing device 3900. The computing device 3900 may at least comprise one or more processors or processing units 3910, a memory 3920, a storage unit 3930, one or more communication units 3940, one or more input devices 3950, and one or more output devices 3960.

In some embodiments, the computing device 3900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3900 can support any type of interface to a user (such as “wearable” circuitry and the like).

The processing unit 3910 may be a physical or virtual processor and can implement various processes based on programs stored in the memory 3920. In a multi-processor system, multiple processing units execute computer executable instructions in parallel so as to improve the parallel processing capability of the computing device 3900. The processing unit 3910 may also be referred to as a central processing unit (CPU), a microprocessor, a controller or a microcontroller.

The computing device 3900 typically includes various computer storage medium. Such medium can be any medium accessible by the computing device 3900, including, but not limited to, volatile and non-volatile medium, or detachable and non-detachable medium. The memory 3920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3930 may be any detachable or non-detachable medium and may include a machine-readable medium such as a memory, flash memory drive, magnetic disk or another other media, which can be used for storing information and/or data and can be accessed in the computing device 3900.

The computing device 3900 may further include additional detachable/non-detachable, volatile/non-volatile memory medium. Although not shown in FIG. 39, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3940 communicates with a further computing device via the communication medium. In addition, the functions of the components in the computing device 3900 can be implemented by a single computing cluster or multiple computing machines that can communicate via communication connections. Therefore, the computing device 3900 can operate in a networked environment using a logical connection with one or more other servers, networked personal computers (PCs) or further general network nodes.

The input device 3950 may be one or more of a variety of input devices, such as a mouse, keyboard, tracking ball, voice-input device, and the like. The output device 3960 may be one or more of a variety of output devices, such as a display, loudspeaker, printer, and the like. By means of the communication unit 3940, the computing device 3900 can further communicate with one or more external devices (not shown) such as the storage devices and display device, with one or more devices enabling the user to interact with the computing device 3900, or any devices (such as a network card, a modem and the like) enabling the computing device 3900 to communicate with one or more other computing devices, if required. Such communication can be performed via input/output (I/O) interfaces (not shown).

In some embodiments, instead of being integrated in a single device, some or all components of the computing device 3900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3900 may be used to implement video encoding/decoding in embodiments of the present disclosure. The memory 3920 may include one or more video coding modules 3925 having one or more program instructions. These modules are accessible and executable by the processing unit 3910 to perform the functionalities of the various embodiments described herein.

In the example embodiments of performing video encoding, the input device 3950 may receive video data as an input 3970 to be encoded. The video data may be processed, for example, by the video coding module 3925, to generate an encoded bitstream. The encoded bitstream may be provided via the output device 3960 as an output 3980.

In the example embodiments of performing video decoding, the input device 3950 may receive an encoded bitstream as the input 3970. The encoded bitstream may be processed, for example, by the video coding module 3925, to generate decoded video data. The decoded video data may be provided via the output device 3960 as the output 3980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
adjusting, for a conversion between a current video block of a video and a bitstream of the video, a prediction for the current video block, the prediction being determined based on a cross-component prediction scheme; and
performing the conversion based on the adjusted prediction.

2. The method of claim 1, wherein the cross-component prediction scheme comprises at least one of multi-model cross-component linear model (MM-CCLM) or multi-model convolutional cross-component model (MM-CCCM), and the prediction for the current video block is adjusted by filtering the prediction.

3. The method of claim 2, wherein the prediction for the current video block comprises a first prediction sample, the adjusted prediction comprises the filtered first prediction sample, and the filtered first prediction sample is determined based on a weighted sum of a plurality of prediction samples in the prediction for the current video block.

4. The method of claim 3, wherein the filtered first prediction sample is determined based on the following:
$$F ( x , y ) = {\sum }_{k = 0}^{L - 1} {W}_{k} P ( {x}_{k} , {y}_{k} )$$
wherein F(x, y) represents the filtered first prediction sample that is at a coordinate (x, y), L represents the number of the plurality of prediction samples, P(xₖ, yₖ) represents a k-th prediction sample in the plurality of prediction samples, and Wₖ represents a weighting value for the k-th prediction sample, or
wherein the filtered first prediction sample is determined based on the following:
$$F ( x , y ) = ( 8 P ( x , y ) + P ( x - 1 , y - 1 ) + P ( x , y - 1 ) + P ( x + 1 , y - 1 ) + P ( x - 1 , y ) + P ( x + 1 , y ) + P ( x - 1 , y + 1 ) + P ( x , y + 1 ) + P ( x + 1 , y + 1 ) + 8 ) >> 4$$
wherein F(x, y) represents the filtered first prediction sample that is at a coordinate (x, y), and P(s, t) represents a prediction sample in the plurality of prediction samples that is at a coordinate (s, t).

5. The method of claim 2, wherein a filter for filtering the prediction is a 9-taps filter with coefficients as follows:
{{ 1/16, 1/16, 1/16},
{ 1/16, 8/16, 1/16},
{ 1/16, 1/16, 1/16}}.

6. The method of claim 1, wherein a padding process is applied on at least one sample at a boundary of the current video block.

7. The method of claim 1, wherein the prediction for the current video block is adjusted based on at least one reconstructed sample of at least one neighboring block of the current video block.

8. The method of claim 7, wherein the prediction for the current video block is adjusted by filtering the prediction with the at least one reconstructed sample.

9. The method of claim 8, wherein the at least one reconstructed sample comprises neighboring reconstructed samples above the current video block, top N rows of prediction samples of the current video block are filtered with the neighboring reconstructed samples, and N is an integer, or
wherein the at least one reconstructed sample comprises neighboring reconstructed samples left to the current video block, top M columns of prediction samples of the current video block are filtered with the neighboring reconstructed samples, and M is an integer.

10. The method of claim 2, wherein a prediction sample of the current video block is filtered with at least one of the following: a reconstructed sample, a further prediction sample, or a padding sample, or wherein a prediction sample of the current video block is filtered with at least one of the following based on a position of the prediction sample: a reconstructed sample, a further prediction sample, or a padding sample.

11. The method of claim 1, wherein the bitstream comprises a syntax element indicating whether filtering is applied for a block coded with MM-CCLM or MM-CCCM.

12. The method of claim 1, wherein a plurality of cross-component prediction schemes are indicated in the bitstream in a way different from truncated unary coding.

13. The method of claim 12, wherein the plurality of cross-component prediction schemes comprises CCLM-L, CCLM-T, MM-CCLM-L and MM-CCLM-T, or
the plurality of cross-component prediction schemes comprises CCCM-L, CCCM-T, MM-CCCM-L and MM-CCCM-T.

14. The method of claim 12, wherein the bitstream comprises at least one of the following:
a first indication indicating whether left or above direction is applied, or
a second indication indicating whether multiple or single model is applied.

15. The method of claim 1, wherein the method is applicable in a coding tool requiring chroma fusion.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
adjusting, for a conversion between a current video block of a video and a bitstream of the video, a prediction for the current video block, the prediction being determined based on a cross-component prediction scheme; and
performing the conversion based on the adjusted prediction.

19. A non-transitory computer-readable storage medium storing instructions that cause a processor to perform acts comprising:
adjusting, for a conversion between a current video block of a video and a bitstream of the video, a prediction for the current video block, the prediction being determined based on a cross-component prediction scheme; and
performing the conversion based on the adjusted prediction.

20. A non-transitory computer-readable recording medium storing a bitstream of a video which is generated by a method performed by an apparatus for video processing, wherein the method comprises:
adjusting a prediction for a current video block of the video, the prediction being determined based on a cross-component prediction scheme; and
generating the bitstream based on the adjusted prediction.
